(19) United States
(12) Patent Application Publication
(10) Pub. No.: US 2026/0292057 A1
(43) Pub. Date: Sep. 24, 2026

(54) SYSTEM

(71) Applicant: SoftBank Group Corp., Tokyo (JP)

(72) Inventor: Junichi TAMAKI, Tokyo (JP)

(73) Assignee: SoftBank Group Corp., Tokyo (JP)

(21) Appl. No.: 19/566,998

(22) Filed: Mar. 14, 2026

(30) Foreign Application Priority Data
Mar. 19, 2025 (JP) 2025-044987

(51) Int. Cl. H04M 3/22; G10L 15/16; G10L 15/26; G10L 25/63

(52) U.S. Cl. CPC H04M 3/2281; G10L 15/16; G10L 15/26; G10L 25/63; H04M 2203/6027

(57) ABSTRACT

A system includes a processor that is configured to detect a communication from identification information that is not registered in an address book, acquire voice information of the communication and convert the voice information into text data by using a speech recognition technique, generate a prompt for instructing analysis of the text data and input the prompt to a generative AI model, compare an analysis result obtained from the generative AI model with cases stored in information resources, generate warning information based on a result of the comparison, and notify a user of the warning information.

### CROSS-REFERENCE TO RELATED APPLICATION

This application is based on and claims priority under 35 USC 119 from Japanese Patent Application No. 2025-044987 filed on Mar. 19, 2025, the disclosure of which is incorporated by reference herein.

### BACKGROUND

### Technical Field

The present disclosure relates to a system.

Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication devices and call-analysis systems provide limited protection against suspicious communications originating from identification information such as phone numbers that are not registered in an address book. In many cases, when a user, including an elderly user or a user unfamiliar with fraudulent techniques, receives a communication from an unknown source, the user cannot easily determine whether the communication is related to fraudulent activity, an unsolicited sales activity, or a harmless ordinary communication. Known systems may merely show the caller's number or a generic “unknown caller” indication, and do not automatically analyze the content of the communication in real time. As a result, users are exposed to a high risk of falling victim to fraud schemes or being pressured by aggressive sales tactics, because there is no timely, content-based warning derived from the actual voice information of the communication.

Furthermore, existing technologies that perform voice recognition or simple pattern matching often lack the capability to leverage recent or complex cases of fraud and sales activities that are continuously updated in information resources such as online databases. These conventional technologies therefore have difficulty adapting to new fraud patterns and fail to provide sufficiently accurate and context-aware warnings to users. Accordingly, there is a need for a system that can detect communications from unregistered identification information, convert the voice information into text, analyze the text flexibly using a generative AI model, compare the analysis result with cases stored in information resources, and generate and notify context-specific warning information to the user in a timely and easily understandable manner.

### SUMMARY

In order to solve the above-described problems, an embodiment of the present invention provides a system comprising a processor, wherein the processor is configured to detect a communication from identification information that is not registered in an address book. The processor is further configured to acquire voice information of the detected communication and convert the voice information into text data by using a speech recognition technique. The processor is also configured to generate a prompt for instructing analysis of the text data, and to input the prompt to a generative AI model capable of flexibly interpreting and analyzing the content of the communication.

The processor is configured to obtain an analysis result from the generative AI model and compare the analysis result with cases stored in information resources, such as online databases or knowledge bases that contain examples of fraudulent activities and sales activities. Based on a result of this comparison, the processor is configured to generate warning information indicating, for example, a possibility of fraudulent activity or a likelihood that the communication is related to a sales activity with purchase intent. The processor is further configured to notify the user of the generated warning information, for example by visually presenting a warning message via a user interface so that the warning information is immediately displayed.

In a particular embodiment, the processor is configured to cause the warning information to include specific content comprising at least one of “Is there a possibility of fraudulent activity?” and “Is this a sales activity with purchase intent?”, thereby enabling the user to readily understand the nature of the risk and to check details of the warning. By performing detection of communications from unregistered identification information, automatic conversion of voice to text, advanced analysis using a generative AI model, comparison with cases stored in information resources, and generation and notification of context-specific warning information, the system according to the present invention can effectively support the user in identifying potentially harmful communications and reducing the risk of fraud and unwanted sales activities.

The term “system” refers to an arrangement of one or more hardware devices and associated software components that cooperate to execute the processing defined in the claims.

The term “processor” refers to any hardware component or combination of components, including a CPU, GPU, microcontroller, or dedicated logic circuitry, that executes instructions to perform the configured functions of the system.

The term “communication” refers to a transmission of information, including but not limited to a voice call, video call, or other audio-bearing session, between at least two endpoints over a wired or wireless network.

The term “identification information” refers to information used to identify a source or destination of a communication, including but not limited to a telephone number, user ID, account identifier, or network address.

The term “address book” refers to a data structure or storage area that maintains a list of registered identification information items, such as contact entries each associated with a name, phone number, or other identification data.

The term “voice information” refers to audio data representing speech or spoken content included in the communication, regardless of the specific encoding, sampling rate, or file format.

The term “speech recognition technique” refers to any algorithm or process, including rule-based methods, statistical models, or machine learning models, that converts voice information into corresponding text data.

The term “text data” refers to a representation of the content of voice information in a character-based or symbol-based form that can be processed, analyzed, or stored as text by the system.

The term “prompt” refers to a data structure or message that instructs a generative AI model to analyze the text data, and that may include the text data itself, context information, and specific instructions for the analysis.

The term “generative AI model” refers to an artificial intelligence model, such as a large language model or similar generative model, that produces an analysis result or other output based on an input prompt.

The term “analysis result” refers to information output by the generative AI model, including but not limited to classifications, summaries, risk evaluations, or other interpretive data derived from the text data.

The term “information resources” refers to one or more data repositories, including online databases, knowledge bases, case libraries, or other collections of stored cases or examples, that can be used for comparison with the analysis result.

The term “cases” refers to stored instances or examples of communications, including descriptions of fraudulent activities, sales activities, or other reference scenarios, that are used as comparison targets in the information resources.

The term “comparison” refers to a process of evaluating similarity or correspondence between the analysis result and the cases stored in the information resources, using any suitable rule-based, statistical, or machine learning method.

The term “warning information” refers to information generated by the processor that indicates, directly or indirectly, a risk or likelihood that the communication is associated with fraudulent activity, sales activity, or other noteworthy conditions.

The term “user” refers to a person who uses the system or a device on which the system is implemented, and who receives the warning information or otherwise interacts with the system.

The term “notify” refers to causing the warning information to be presented or delivered to the user, including by visual display, audio output, vibration, message transmission, or any combination thereof.

The term “user interface” refers to hardware and software components that present information to the user and/or receive input from the user, including screens, speakers, buttons, touch panels, and graphical user interface elements.

The term “warning message” refers to a representation of the warning information in a form understandable by the user, such as a text phrase, symbol, icon, or combination thereof, presented via the user interface.

The term “immediately display” refers to presenting the warning information to the user without undue delay after generation of the warning information, subject to practical processing and communication constraints.

The term “fraudulent activity” refers to an act or attempt intended to deceive the user for unlawful gain or other improper purpose, including but not limited to so-called “ore-ore” fraud, phishing, or financial scams.

The term “sales activity” refers to an act or attempt to promote, offer, or sell goods or services to the user, including telemarketing, solicitation calls, and other purchase-inducing communications.

The term “purchase intent” refers to an intention or expectation that the user will enter into a transaction to acquire goods or services as a result of the sales activity.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

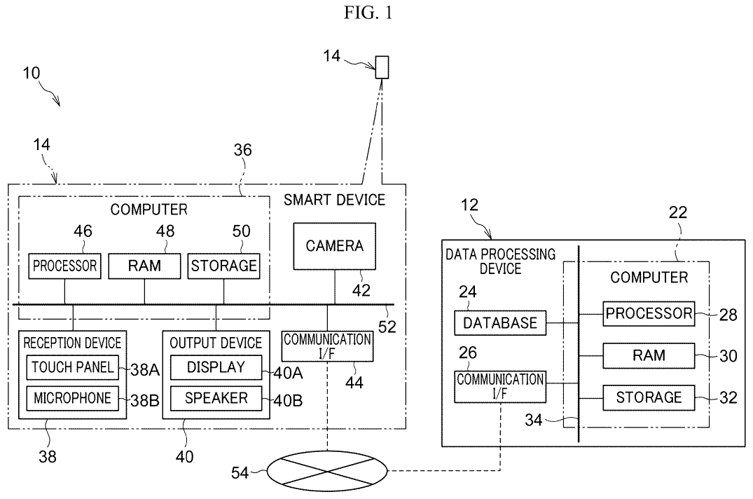

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

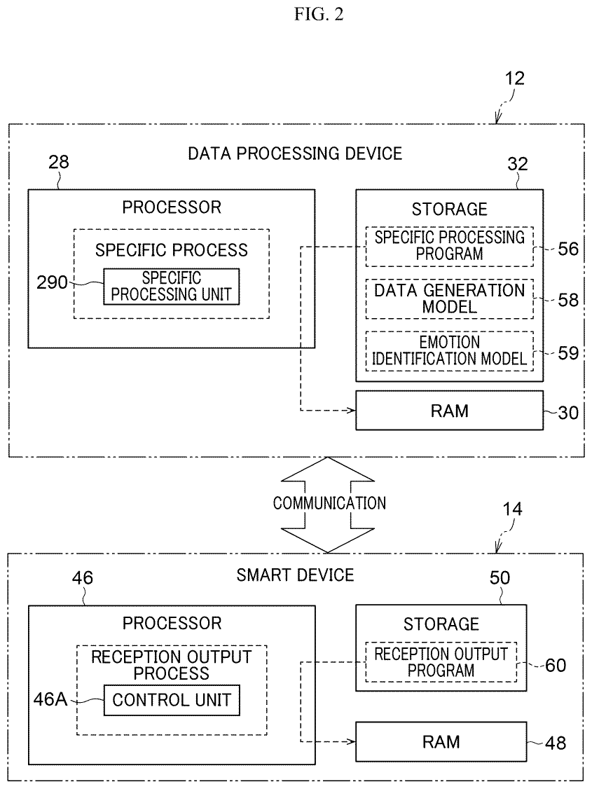

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional communication management systems executing on general-purpose computers typically treat calls from unknown identifiers in a uniform manner, such as by simple caller identification suppression or static blacklists, without performing any deep semantic analysis of the content of the communication. As a result, such systems often fail to accurately distinguish between high-risk communications, such as fraudulent or aggressively solicitational calls, and low-risk or legitimate calls. This leads to two major technical problems in computer-implemented call handling: excessive false positives, where benign calls are incorrectly flagged and unnecessarily interrupted, and excessive false negatives, where harmful calls are not identified in time for effective user intervention.

In addition, existing approaches that attempt content-based analysis generally rely on rule-based keyword filters or static pattern matching executed by the computer processor. These approaches are computationally brittle, difficult to maintain, and poorly adapted to evolving fraud patterns or diverse linguistic expressions. As the volume of communications increases and fraud schemes become more sophisticated, such rule-based systems impose increased processing overhead on communication devices and servers, and still provide low-quality risk assessment, thereby degrading the efficiency of call handling workflows performed by the underlying computer systems.

Moreover, the mere use of a machine learning model to classify calls, without careful orchestration of input data structures, prompt design, and structured outputs, tends to produce unstructured, non-deterministic responses that are difficult for the computer to consume automatically. Without a mechanism for the processor to control how a generative AI model is prompted and how its output is structured, the downstream components of the system must perform complex, ad hoc parsing, which increases processing latency and error rates, and reduces the reliability of automated warning generation.

Accordingly, there is a need for an improved computer-implemented system that: (i) automatically identifies communications from unregistered identifiers at the communication terminal level; (ii) efficiently acquires and transforms communication audio into machine-processable text; (iii) utilizes a generative AI model in a processor-controlled manner through explicitly defined prompt sentences and structured response formats; and (iv) generates and delivers structured warning information to the terminal with reduced computational overhead and improved accuracy. In particular, there is a need to improve the way processors orchestrate speech recognition engines, generative AI models, and information resources so that the overall computer system can more accurately and efficiently classify communication risk, reduce unnecessary user interruptions, and enhance the technical performance of call handling and notification subsystems.

The specific processing by the specific processing unit 290 of the data processing device 12 in Example 1 is realized by the following means.

The present invention provides a server comprising a processor configured to receive, from a communication terminal, recording data representing audio information of a communication detected as having identification information not registered in a contact storage unit of the communication terminal, to convert the recording data into text data by using a speech recognition technique, to generate analysis request data including the text data and a prompt sentence that instructs a generative AI model to classify the communication with respect to at least fraudulent activity, unnecessary sales activity, and low-risk activity and to output an analysis result in a predetermined structured format, to input the analysis request data to the generative AI model and obtain the analysis result, to compare the analysis result with an information resource storing a plurality of case data to determine a risk type and a risk level for the communication, to generate warning information including the risk type, the risk level, and a concise reason description based on the structured format, and to transmit notification data including the warning information to the communication terminal so that the warning information is presented to a user via the communication terminal. This enables the underlying computer system to perform an integrated and automated sequence of operations—ranging from detection of unregistered communications, through speech-to-text conversion and structured generative AI analysis, to risk-aware warning generation and delivery—in a manner that improves the technical performance of call handling and notification functions by reducing misclassification rates, reducing processing overhead for downstream parsing, and providing machine-readable, structured outputs that can be consumed reliably by computer components without extensive post-processing.

The term “processor” refers to one or more hardware computation units, such as a central processing unit, a digital signal processor, or a hardware accelerator, that execute instructions to perform the functions described, including detection of communications, data conversion, analysis coordination, and generation of warning information.

The term “communication terminal” refers to an electronic device configured to send and receive communications over a network, such as a mobile telephone, a smartphone, a tablet terminal, or a personal computer, that is capable of presenting information to a user.

The term “contact storage unit” refers to a data storage resource, such as a contacts database or an address book, that stores records associating identifiers with contact entries for use by the communication terminal in determining whether an identifier is registered.

The term “identification information” refers to information that uniquely or semi-uniquely identifies a source or destination of a communication, including but not limited to a telephone number, a network address, a user identifier, or a session identifier.

The term “communication” refers to an exchange of information between endpoints over a communication network, including but not limited to a voice call, a voice-over-network session, or a similar audio-based connection.

The term “audio information” refers to electronic data representing sound associated with a communication, including analog voice signals converted into digital form suitable for storage and processing by a computer system.

The term “recording data” refers to audio information that has been captured over a period of time and stored as a discrete data set or file, such as a digital audio recording of a communication session.

The term “speech recognition technique” refers to a software-implemented process executed by a computing device that analyzes audio information and produces corresponding text data, including automatic speech recognition algorithms and associated language models.

The term “text data” refers to a sequence of characters or symbols representing linguistic content that has been derived from audio information and is suitable for processing by software components, including analysis by a generative AI model.

The term “analysis request data” refers to a structured data set prepared for input to a generative AI model, including at least the text data obtained from the communication and one or more instructions specifying an analysis task.

The term “prompt sentence” refers to textual instruction data included in the analysis request data that guides the operation of a generative AI model, including directives on how to classify the communication and how to format the analysis result.

The term “generative AI model” refers to a machine learning model, such as a neural network-based language model, configured to generate output text or structured data in response to input data and a prompt sentence, and capable of performing semantic analysis and classification.

The term “analysis result” refers to output data produced by the generative AI model in response to the analysis request data, including classifications, risk assessments, or explanatory information regarding the communication.

The term “information resource” refers to a data storage entity accessible by the processor, such as a database or knowledge base, that stores a plurality of case data for use in comparing and refining the analysis result to determine a risk type and risk level.

The term “case data” refers to stored records representing example communications, patterns, or labeled instances of fraudulent activity, unnecessary sales activity, or other categories, which are used as reference data in risk determination.

The term “risk type” refers to a classification category assigned to a communication, such as a category representing fraudulent activity, unnecessary sales activity, low-risk activity, or other types of behavior.

The term “risk level” refers to an indication of severity or likelihood associated with the risk type of a communication, such as high, medium, or low, that is determined based on the analysis result and information resource.

The term “warning information” refers to data generated by the processor that indicates a potential risk associated with a communication, including at least the risk type, the risk level, and a concise explanation for presentation to a user.

The term “concise reason description” refers to a short textual explanation included in the warning information that summarizes why the communication has been assigned a particular risk type and risk level.

The term “notification data” refers to a data set transmitted from the server-side system to the communication terminal, including the warning information and any associated metadata used to trigger a user-facing notification.

The term “notification function” refers to a capability of a terminal device operating system or application framework that allows visual or audible alerts, such as banners, pop-up messages, or status bar notifications, to be presented to a user.

The term “user interface processing” refers to operations executed by the communication terminal to render, display, and manage interactive elements presented to a user, including the display of warning messages and the reception of user input.

The term “visual warning message” refers to a graphical or textual indication displayed on a screen of the communication terminal that conveys the warning information related to a communication.

In one embodiment, a server, a terminal, and a user cooperate to implement the claimed system.

### A. Overall Configuration

The server includes a processor, a main memory, a non-volatile storage device, and a network interface. The processor executes server-side application software stored in the storage device and loaded into the main memory. The network interface connects the server to external networks through wired or wireless communication.

The terminal includes a processor, a memory, a communication module, a microphone, a display, and an input device such as a touch panel. The processor of the terminal executes an operating system, such as a mobile operating system, and an application program providing call monitoring and warning presentation functions.

The user operates the terminal to initiate and receive communications, to view warnings, and to provide feedback such as blocking or allowing specific communications.

### B. Terminal-side Functions and Data Structures

The terminal maintains a contact storage unit. The contact storage unit is implemented as a structured database maintained by the operating system or by an application, with each record including fields such as identifier (for example, telephone number), display name, and additional metadata. The terminal uses indexed access (for example, hash-based or tree-based indexing) to compare incoming identification information against stored identifiers with low latency.

The terminal includes a call monitoring module. The call monitoring module uses operating-system-level telephony or session APIs to receive identification information when a communication is initiated. When the terminal detects that the identification information is not present in the contact storage unit, the terminal classifies the communication as unregistered and stores a call session record in memory, including fields for identifier, time, and a recording flag.

The terminal includes an audio capture module. The audio capture module activates the microphone and an audio driver to obtain audio information associated with the unregistered communication. The audio capture module converts analog signals from the microphone into digital data using an analog-to-digital converter and encodes the data using a codec such as pulse-code modulation. The terminal stores the encoded audio in a recording buffer in memory and periodically flushes the buffer to a recording file in non-volatile storage. The recording file includes a header describing sampling rate, encoding format, and duration.

The terminal includes an upload module. The upload module reads the recording file and constructs a request message to the server, including the recording data, the identification information, a timestamp, and a device identifier. The upload module encapsulates this information in a structured transport format and sends it to the server through a secure communication channel under control of the processor.

The terminal includes a notification module. The notification module receives notification data from the server via a push notification service or via a direct communication channel. The notification module parses the notification data to obtain warning information, including a risk type, a risk level, and a concise reason. The terminal displays a visual warning message on the display, for example as an overlay or banner, and associates user interface elements with operations such as “Block this number” or “Allow this call.”

### C. Server-Side Modules and Data Structures

The server includes a reception module. The reception module receives recording data and associated metadata from the terminal. The server stores the recording data in an audio storage area, where each entry is indexed by a request identifier. The server stores the associated metadata, such as identification information, timestamps, and device identifiers, in a relational table or document collection, with key-based access for subsequent retrieval.

The server includes a speech recognition interface module. The speech recognition interface module accesses the recording data, segments the audio into frames, and formats a request payload for an external or internal speech recognition engine. In one embodiment, the server uses a remote speech recognition service implemented as a deep neural network, such as a recurrent or transformer-based acoustic model combined with a statistical or neural language model. The speech recognition engine receives the audio frames and outputs recognized text segments with confidence scores.

The server stores the recognized text in a transcript storage area. Each transcript is associated with the request identifier and includes fields such as the full text string, segment boundaries, and average confidence. The server optionally filters out low-confidence segments or marks them for reduced weight in later analysis.

The server includes a prompt generation module. The prompt generation module constructs analysis request data comprising the text data and a prompt sentence. The prompt sentence defines classification targets, response format, and risk criteria in a form consumable by a generative AI model. The prompt generation module adapts the prompt content based on language, communication type, or previous system behavior, using rules stored in a configuration database.

In one representative example, the server generates a prompt sentence such as: “This is a transcript of a phone call from an unknown caller.

Transcript:
‘This is a limited-time investment offer. You will get guaranteed returns if you transfer the funds today.’

Analyze this transcript and determine whether the call is:
Fraud
Unwanted Sales
Low Risk

For your answer, provide:
1) Category (Fraud, Unwanted Sales, or Low Risk)
2) Risk level (High, Medium, or Low)
3) One-sentence explanation for your decision.”

In another example, the server generates a prompt sentence such as:
“Analyze the following phone call transcript from an unknown number:
‘We are from the tax office. You must pay an immediate penalty by purchasing gift cards and sending us the codes.’

Decide if this call is likely to be a scam or unwanted sales. Output:
Risk level (High, Medium, or Low)
One short justification.”

The server includes a generative AI model interface module. The generative AI model interface module formats the analysis request data, including the text data and the prompt sentence, into an input representation for a generative AI model. In one embodiment, the generative AI model is a transformer-based neural network with multiple self-attention layers, position-wise feed-forward networks, and learned token embeddings. The model parameters are obtained by pre-training on large-scale text corpora and optionally fine-tuning on labeled communication data such as scam transcripts and legitimate call transcripts.

The server represents the text data and the prompt sentence as sequences of tokens using a subword tokenization algorithm. The generative AI model processes the token sequences by computing attention scores between tokens, producing context-aware hidden state vectors, and applying a final projection to a vocabulary or to special output tokens representing structured labels. The model output is returned as a sequence of tokens representing a category, a risk level, and an explanation phrase.

The server includes a response parser module. The response parser module parses the output of the generative AI model to extract values matching the requested structured format. For example, the server extracts a category string such as “Fraud,” a risk level string such as “High,” and an explanation sentence such as “The caller promises guaranteed returns and requests immediate money transfer, which is typical of scam behavior.” The server normalizes these values and validates them against allowed categories and levels.

The server includes an information resource module. The information resource module maintains a collection of case data, each case representing a known pattern of fraudulent activity, unwanted sales activity, or low-risk communications. Each case entry contains features such as typical phrases, statistical patterns such as term frequencies, and labeled outcomes. The server compares the analysis result obtained from the generative AI model with these case data by computing similarity measures, such as cosine similarity of vector embeddings or overlap of keyword sets.

The server refines the risk type and risk level based on this comparison. For example, when the generative AI model assigns “Unwanted Sales” with “Medium” risk, and the text shares high similarity with known high-risk fraudulent cases, the server can elevate the risk level or change the risk type under a predetermined rule. The server records the final risk type and risk level in a risk assessment record.

The server includes a warning generation module. The warning generation module constructs warning information, incorporating the final risk type, risk level, and a concise reason description. The concise reason description is derived from the explanation output by the generative AI model and optionally enriched or shortened by additional template-based processing. The warning information further includes the identification information and may include suggested user actions, such as advising the user to hang up or not to disclose personal information.

The server includes a notification delivery module. The notification delivery module formats notification data using the warning information and sends the notification data to the terminal. The notification delivery module interfaces with a push notification service or directly with the terminal via a persistent communication channel. The notification delivery module ensures reliable delivery by including identifiers for re-try logic and logs delivery status for monitoring.

### D. Generative AI Model Training and Operation

The server prepares a training dataset composed of multiple communication transcripts, each labeled with a category such as fraudulent activity, unwanted sales activity, or low-risk, and labeled with risk levels. The server uses this dataset to fine-tune a transformer-based language model. The server defines a loss function that measures a combination of classification error and format compliance error. The classification error is computed, for example, as cross-entropy between predicted category distributions and ground-truth labels. The format compliance error penalizes outputs that deviate from the required structured pattern.

The server updates model parameters using gradient-based optimization methods, such as stochastic gradient descent with adaptive learning rate strategies. The server performs training in mini-batches and may use regularization techniques such as dropout applied to attention layers and feed-forward layers. The server may apply data augmentation, such as paraphrasing of training transcripts or insertion of noise phrases, to improve model robustness against variation in speech content.

During inference, the server controls the generative AI model by specifying decoding parameters, such as temperature, maximum output length, and stop conditions. The server thus constrains the model to produce concise, structured outputs. This control reduces output variance and simplifies parsing, thereby improving both computational efficiency and robustness of the downstream processing.

### E. Technical Effects and Improvements

The server coordinates speech recognition, generative AI analysis, and information resource comparison in a specific sequence and with specific data structures. Because the server presents the generative AI model with a well-structured prompt sentence and expects a predetermined structured output, the server avoids heavy natural language parsing and reduces CPU cycles spent on unstructured text analysis. This improves processing speed for each communication and allows the system to scale efficiently to large volumes of calls.

The use of a transformer-based generative AI model, trained and fine-tuned as described, enables the server to capture long-range dependencies in call transcripts and to recognize fraudulent patterns that cannot be reliably captured by simple keyword-based filters or rule-based systems. The server thereby reduces false negatives by more accurately detecting non-obvious fraud patterns, and reduces false positives by identifying benign calls where words that resemble scam patterns appear in harmless contexts.

The information resource module introduces a secondary, rule-based refinement that uses similarity metrics and historical case data. This combination of neural semantic analysis and explicit similarity-based refinement provides a hybrid decision mechanism. The hybrid mechanism yields improved stability and transparency compared to purely model-based or purely rule-based systems, which leads to lower error rates and more predictable behavior.

The server and the terminal cooperate to minimize communication and processing load. The terminal only uploads audio data for calls identified as unregistered, which reduces bandwidth consumption and server-side processing. The server converts audio to text using a speech recognition engine that is optimized for batch processing, thereby reducing redundant computation on the terminal. The system thus achieves improved use of network and computing resources compared to naive designs that would analyze all calls or perform duplicated processing at both ends.

The system operates within the constraints of existing communication networks and device capabilities but improves technical performance of call handling infrastructure. The server automatically structures and compresses complex semantic information into compact warning information, which the terminal can display with minimal processing. As a result, the terminal can present risk-aware warnings with low latency, even on resource-constrained hardware.

### F. Alternative Embodiments

In another embodiment, the terminal performs the speech recognition locally using an on-device acoustic model and language model. In this case, the terminal converts the recording data into text data and transmits only the text to the server, thereby reducing network load. The server in such an embodiment still performs generative AI analysis, information resource comparison, and warning generation as described.

In another embodiment, the generative AI model is deployed on the server itself instead of being accessed as an external service. The server stores model parameters in local storage and loads them into memory. The server uses hardware acceleration such as graphics processing units or tensor processing units to execute matrix multiplications in the transformer layers, which reduces inference latency and increases throughput.

In another embodiment, the server generates different types of prompt sentences depending on the communication type. For example, the server uses one prompt sentence tailored for financial-related communications and another prompt sentence for technical support-related communications. The server identifies the communication type from the initial portion of the transcript by applying a lightweight classifier, and then selects an appropriate prompt template. This multi-prompt strategy further improves classification accuracy and reduces the risk of misinterpretation by the generative AI model.

In another embodiment, the server updates parts of the information resource and the generative AI prompt templates based on feedback from users. When the user indicates that a warning was incorrect, the server records this feedback and at a later time retrains the model or adjusts rule thresholds. This feedback loop improves the technical performance of the system over time by adapting to new fraud patterns and evolving language use.

In yet another embodiment, the terminal provides additional machine-readable context to the server, such as geographic location or time-of-day information. The server encodes this context as features and, in some configurations, appends a short textual description of the context into the prompt sentence. This allows the generative AI model and the refinement logic to condition classification on contextual patterns, such as calls that occur at unusual times or from regions associated with high fraud rates.

Through these embodiments, the server and the terminal implement not merely an automation of a human fraud-detection task, but a specific technical architecture and sequence of operations that improve how computer systems process, classify, and present communication risk. The defined data structures, prompt control, model architecture, and hybrid refinement algorithms yield faster, more accurate, and more resource-efficient operation than conventional techniques, thereby constituting an improvement in computer technology itself.

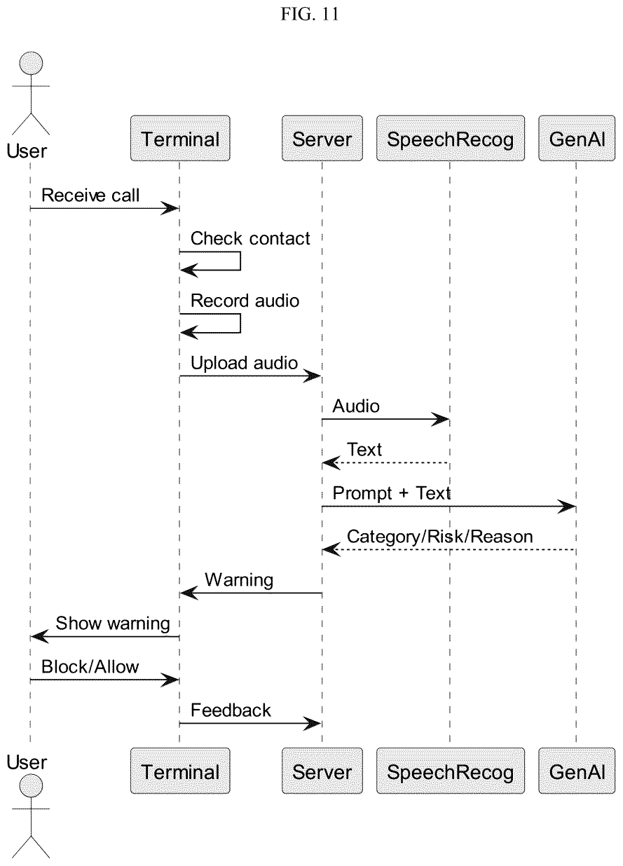

The following describes the processing flow using FIG. 11.

### Step 1

The terminal monitors incoming communications using a telephony or session API of an operating system.

The terminal receives, as input, identification information associated with each incoming communication (for example, a telephone number or network address).

The terminal queries a contact storage unit with the identification information as a search key and compares the identification information with stored contact records.

The terminal produces, as output, a determination indicating whether the identification information is registered or unregistered, and creates an internal call session record including the identification information and a flag indicating an unregistered communication.

### Step 2

The terminal, when the communication is determined to be unregistered and becomes active, starts capturing audio information associated with the communication.

The terminal receives, as input, an analog audio signal from a microphone during the communication.

The terminal converts the analog audio signal into digital audio samples using an analog-to-digital converter and encodes the samples into a digital format such as pulse-code modulation with a defined sampling rate and bit depth.

The terminal stores the encoded audio data into a recording buffer and periodically writes the buffered data to a recording file in a storage device.

The terminal produces, as output, recording data representing the audio information, and updates the call session record with a reference to the recording file.

### Step 3

The terminal detects termination of the unregistered communication by monitoring a telephony or session state.

The terminal receives, as input, a state change event indicating that the call has ended and a reference to the associated recording data.

The terminal stops audio capture, flushes any remaining audio data from the recording buffer to the recording file, and closes the file handle to ensure data integrity.

The terminal checks the file's metadata such as duration and size to confirm that valid recording data exists.

The terminal produces, as output, finalized recording data and metadata such as duration and timestamp, stored in association with the call session record.

### Step 4

The terminal prepares an upload request for the server containing the recording data and associated metadata.

The terminal receives, as input, the finalized recording data, the identification information, a timestamp, and a device identifier.

The terminal constructs a structured request message, for example using a multipart or binary format, and embeds the recording data and the metadata into the message.

The terminal performs data processing including optional compression of audio data and serialization of metadata fields.

The terminal transmits the request message over a secure communication channel to the server.

The terminal produces, as output, a network message sent to the server that contains the recording data and associated fields.

### Step 5

The server receives the network message from the terminal via a network interface.

The server receives, as input, the structured request message containing recording data and metadata including identification information, timestamp, and device identifier.

The server parses the message, extracts the recording data, and stores the recording data in an audio storage area.

The server stores the metadata in a database record and creates a request identifier that links the audio storage entry and the metadata entry.

The server produces, as output, stored audio data indexed by the request identifier and a corresponding metadata record accessible for subsequent processing.

### Step 6

The server invokes a speech recognition module to convert the recording data into text data.

The server receives, as input, the recording data associated with a specific request identifier.

The server segments the recording data into frames and formats the data according to requirements of a speech recognition engine, including specifying encoding, sampling rate, and language.

The server sends the formatted audio data to the speech recognition engine and receives a sequence of recognized tokens with confidence scores.

The server concatenates the tokens into a transcript string, optionally discarding low-confidence segments or marking them for reduced weight.

The server produces, as output, text data representing a transcript of the communication, stored in association with the request identifier.

### Step 7

The server generates prompt sentences and analysis request data for a generative AI model.

The server receives, as input, the text data, the identification information, and optionally context information such as language and time-of-day.

The server constructs a prompt sentence that describes the analysis task, specifies categories such as fraud, unwanted sales, and low risk, and defines a desired output structure.

The server combines the text data and the prompt sentence into analysis request data, for example by embedding the transcript into the body of the prompt sentence.

The server, for example, generates a prompt sentence such as: “This is a transcript of a phone call from an unknown caller.

Transcript:
‘This is a limited-time investment offer. You will get guaranteed returns if you transfer the funds today.’

Analyze this transcript and determine whether the call is:
Fraud
Unwanted Sales
Low Risk

For your answer, provide:
1) Category (Fraud, Unwanted Sales, or Low Risk)
2) Risk level (High, Medium, or Low)
3) One-sentence explanation for your decision.”

The server produces, as output, structured analysis request data ready to be input to the generative AI model.

### Step 8

The server inputs the analysis request data to the generative AI model and obtains an analysis result.

The server receives, as input, the analysis request data including the prompt sentence and the text data.

The server tokenizes the text and the prompt sentence into subword units, forms a token sequence, and sends this sequence to a transformer-based generative AI model via an inference API.

The generative AI model processes the tokens through multiple attention layers and feed-forward layers to compute context-aware representations and generates output tokens representing category, risk level, and explanation.

The server collects the output tokens and converts them back to text strings.

The server produces, as output, an analysis result that includes at least a category (for example, “Fraud”), a risk level (for example, “High”), and a free-text explanation, all associated with the request identifier.

### Step 9

The server refines the analysis result using an information resource and determines a final risk type and risk level.

The server receives, as input, the analysis result from the generative AI model and a set of case data stored in an information resource.

The server transforms the transcript and case data into vector representations using a feature extraction method, such as embedding models or term-frequency statistics.

The server computes similarity scores between the transcript features and features of stored case data and evaluates rule-based conditions that adjust the category or risk level when similarity exceeds predefined thresholds.

The server determines a final risk type and risk level by combining the model output with the similarity-based refinement, for example by elevating risk when the transcript closely matches high-risk cases.

The server produces, as output, a refined risk type and risk level for the communication, stored in a risk assessment record.

### Step 10

The server generates warning information based on the refined risk type and risk level.

The server receives, as input, the refined risk type, the refined risk level, the identification information, and the explanation text from the analysis result.

The server composes warning information that includes fields such as a warning title, a human-readable summary, the risk type, the risk level, and a concise reason description.

The server may apply template-based formatting to ensure consistency, for example generating text such as “Possible scam call detected. Risk: High. The caller promises guaranteed returns and demands immediate transfer of funds.”

The server produces, as output, structured warning information associated with the request identifier.

### Step 11

The server prepares and sends notification data containing the warning information to the terminal.

The server receives, as input, the warning information and a device identifier or token for the terminal.

The server formats notification data that encapsulates the warning information in a payload suitable for a push notification service or direct messaging protocol.

The server transmits the notification data through a network interface to the push notification service or directly to the terminal.

The server produces, as output, a network message containing the warning information that will be delivered to the terminal.

### Step 12

The terminal receives the notification data and presents a warning to the user.

The terminal receives, as input, the notification data containing the warning information via a push notification channel or direct communication channel.

The terminal parses the notification data to extract the warning title, summary, risk type, risk level, and concise reason description.

The terminal uses a notification function of the operating system to display a visual warning message on the display, for example as a banner or pop-up indicating that the communication from the given identification information may be fraudulent or unwanted sales.

The terminal produces, as output, a user-visible warning that informs the user of the communication risk and allows the user to respond accordingly.

### Step 13

The user observes the warning message on the terminal and decides how to handle the communication.

The user receives, as input, the displayed visual warning message including information about risk type, risk level, and reason.

The user interacts with the terminal's user interface elements to select an action, such as blocking the identification information, allowing future communications, or reporting incorrect classification.

The terminal receives the user's selection and updates local records, such as a block list, and optionally sends feedback to the server about the correctness of the warning.

The terminal and the server produce, as output, updated configuration and feedback data that can influence future processing for similar communications.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional call-screening technologies rely primarily on static blocklists, simple pattern matching of caller identifiers, and coarse spam scores provided by external reputation databases. These approaches suffer from several technical deficiencies when executed on computer systems. First, they have difficulty handling previously unseen caller identifiers, because the decision logic depends heavily on prior registration in a directory or on pre-existing blacklists. As a result, a computing system that encounters a new or obfuscated identifier frequently produces an indeterminate or low-quality risk assessment, which degrades the effectiveness of automated call filtering.

Second, traditional rule-based fraud detection logic executed by a processor is not well suited to understanding the semantic content of conversational audio. Even when speech recognition is employed, conventional systems often apply only keyword matching or handcrafted rules to the resulting text. Such rules are brittle, hard to maintain, and computationally inefficient when the rule base grows, thereby imposing processing overhead on the processor and limiting scalability. Furthermore, these systems cannot flexibly adapt to evolving social engineering tactics that change phrasing while preserving fraudulent intent.

Third, there is a lack of integrated mechanisms in existing architectures to combine multi-source information in a consistent, machine-usable format. Audio-derived text, outputs from advanced generative artificial intelligence models, and external communication history resources are often processed in separate subsystems without a unified representation. This fragmented processing leads to suboptimal memory utilization, redundant computation, and inconsistent risk evaluations across calls, which in turn hampers the reliability of the computer system as a whole.

Fourth, user feedback regarding specific calls, such as user actions to block, ignore, or accept calls, is typically not incorporated back into the core decision logic in a structured way. As a consequence, the system fails to refine its internal models, prompt constructions, and evaluation thresholds over time, resulting in a non-learning architecture in which the computing behavior remains static despite the availability of real-world interaction data.

Accordingly, there is a need for improved computer-implemented techniques that, when executed by a processor, (i) transform raw audio from unregistered communications into structured text data; (ii) generate and supply prompt sentences to a generative artificial intelligence model to obtain enriched semantic analysis; (iii) integrate the model's analysis with external information resources and historical communication data to produce machine-interpretable evaluation information including risk levels and reasons; and (iv) adapt subsequent processing by updating stored history information and correcting generation conditions based on user feedback. Such techniques are required to improve the accuracy, robustness, and computational efficiency of fraud-risk assessment for unregistered communications in a manner that enhances the operation of the underlying computer system itself, rather than merely automating a human mental process.

The specific processing by the specific processing unit 290 of the data processing device 12 in Application Example 1 is realized by the following means.

The present invention provides a server comprising a processor and a memory storing directory information and communication history information, the processor being configured to detect, via a communication interface, that identification information included in incoming call information received from a terminal device is not present in the directory information and thereby detect an unregistered communication, to acquire audio information associated with the unregistered communication from at least one of the terminal device and the memory, to input the audio information to a speech recognition apparatus so as to obtain text data converted from the audio information and store the text data in association with the identification information in the memory, to generate a prompt sentence including at least the text data and contextual information related to the unregistered communication and transmit the prompt sentence as input to a generative artificial intelligence model executed by an information processing apparatus so as to obtain an analysis result, to compare the analysis result with reference information including at least one of external information resources accessible via a network and the communication history information stored in the memory and generate evaluation information indicating at least a risk level of fraudulent activity and a reason for the risk level based on the analysis result and a comparison result, to create warning information corresponding to the evaluation information and transmit notification data including the warning information to the terminal device so as to cause the terminal device to display the warning information to a user, and to update, based on at least one of a response operation and an evaluation operation received from the terminal device, at least one of the identification information and the evaluation information stored in the memory as history information and correct at least one of a generation condition of the prompt sentence and a generation condition of the evaluation information. This enables the computer system to perform a technically improved sequence of data transformations and decision operations in which raw audio from unregistered communications is converted into structured text, semantically analyzed by a generative artificial intelligence model using explicitly constructed prompt sentences, correlated with multi-source reference data to produce machine-usable risk evaluations, and adaptively refined based on user feedback, thereby enhancing the accuracy, consistency, and efficiency of fraud-risk assessment and improving the overall operation of the underlying computing infrastructure.

The term “processor” refers to one or more hardware logic elements, such as a central processing unit, a microcontroller, or a processing core, that execute instructions to perform operations on data and control the functions of the system.

The term “memory” refers to one or more non-transitory computer-readable storage media, such as semiconductor memory, magnetic storage, or optical storage, that store data and instructions for access by the processor.

The term “directory information” refers to data stored in the memory that associates identification information, such as communication identifiers or contact identifiers, with corresponding contact records, and that is used to determine whether an incoming communication is registered or unregistered.

The term “communication history information” refers to data stored in the memory that represents past communications, including at least identification information, time information, evaluation information, and user feedback associated with each communication.

The term “identification information” refers to data that uniquely or semi-uniquely identifies a communication source or destination, such as a communication number, a network address, or other caller or sender identifier.

The term “incoming call information” refers to data received from a terminal device that indicates details of an incoming communication, including at least identification information and time information, and optionally state information and call attributes.

The term “unregistered communication” refers to an incoming communication for which identification information included in the incoming call information is not present in the directory information stored in the memory.

The term “terminal device” refers to an information processing apparatus operated by a user, such as a mobile communication device, a smartphone, a tablet, or a personal computer, that transmits incoming call information and receives notification data.

The term “communication line” refers to a wired or wireless communication medium, such as a public network, a private network, or a packet-switched network, through which data is transmitted between the server and the terminal device.

The term “audio information” refers to digital data representing sound associated with a communication, including at least voice signals of a caller, which is usable as input for speech recognition processing.

The term “speech recognition apparatus” refers to a hardware device, software module, or combination thereof, configured to receive audio information and convert the audio information into corresponding text data using a speech recognition technique.

The term “speech recognition technique” refers to a computational method, implemented in software and/or hardware, that analyzes audio information and outputs a sequence of characters or words representing the content spoken in the audio information.

The term “text data” refers to character-based data generated by the speech recognition apparatus that represents at least part of the semantic content of the audio information associated with a communication.

The term “prompt sentence” refers to a structured natural language or formal language string that includes at least the text data and contextual information and that is provided as input to a generative artificial intelligence model to request a specific analysis or output.

The term “contextual information” refers to data describing attributes of a communication apart from its literal text content, including at least information such as communication type, time, duration, identifier pattern, or previous evaluation results.

The term “generative artificial intelligence model” refers to a machine-learned computational model capable of generating output data, such as analysis results or classifications, in response to input data including a prompt sentence, by using statistical or neural network-based techniques.

The term “information processing apparatus” refers to one or more hardware devices, such as servers or computing nodes, configured to execute software including at least the generative artificial intelligence model or the speech recognition apparatus.

The term “analysis result” refers to data output from the generative artificial intelligence model in response to the prompt sentence, the data including at least an assessment related to fraudulent activity and explanatory information.

The term “reference information” refers to data used as a basis for comparison with the analysis result, including at least one of external information resources accessible via a network and communication history information stored in the memory.

The term “external information resources” refers to data sources outside the server, such as remote databases, network services, or information repositories, that provide information related to communications, identifiers, or fraud patterns.

The term “evaluation information” refers to data generated by the processor based on the analysis result and the reference information, the data including at least a risk level indicating a likelihood of fraudulent activity and a reason for the risk level.

The term “risk level” refers to a value or category indicating a degree of likelihood that a communication is associated with fraudulent activity, such as a discrete label (for example, high, medium, low) or a numerical score.

The term “reason” refers to explanatory information associated with the risk level that describes, in human-readable form, one or more factors or patterns supporting the assigned risk level.

The term “warning information” refers to data representing a message intended to alert a user to a potential risk associated with a communication, the message including at least the risk level and optionally the reason.

The term “notification data” refers to data transmitted from the server to the terminal device that includes the warning information and, optionally, additional metadata used to control presentation of the warning information on the terminal device.

The term “response operation” refers to a user action performed on the terminal device in reaction to the warning information, such as accepting a call, terminating a call, blocking an identifier, or ignoring a warning.

The term “evaluation operation” refers to a user action performed on the terminal device that provides explicit feedback regarding the correctness or relevance of the warning information, such as labeling a communication as fraudulent, suspicious, or legitimate.

The term “history information” refers to accumulated data stored in the memory that records past communications, associated evaluation information, and user operations, and that is used to influence subsequent processing by the processor.

The term “generation condition of the prompt sentence” refers to one or more rules, parameters, or templates used by the processor to construct a prompt sentence, including selection of included fields, wording patterns, and formatting structures.

The term “generation condition of the evaluation information” refers to one or more rules, thresholds, weighting factors, or algorithms used by the processor to generate evaluation information from the analysis result and the reference information.

The term “display screen” refers to an output device of the terminal device, such as a liquid crystal display or an organic light-emitting diode display, used to visually present warning information and other user interface elements.

The term “emphasis level” refers to a presentation attribute of warning information, such as color, size, highlighting, or alert style, that is varied according to the risk level to influence user attention.

The term “wording” refers to specific textual expressions and phrases used in the warning information, which may be changed in accordance with the risk level or other aspects of the evaluation information.

In one embodiment, a server cooperates with one or more terminal devices operated by users to implement the claimed system. The server includes at least one processor, a main memory, a non-transitory storage device, and a network interface. The terminal includes at least one processor, a memory, an audio input unit such as a microphone, a display screen, and a communication interface. The server and the terminal are connected through a wired or wireless communication network, such as a cellular network and an IP-based packet network.

The server stores, in the memory, directory information associating identification information such as communication numbers with contact records, and communication history information representing past communications and their evaluation results. The server also stores configuration data defining generation conditions for a prompt sentence and generation conditions for evaluation information. In some embodiments, the server further stores model parameters or access credentials for external services implementing a speech recognition apparatus and a generative AI model.

The terminal acquires incoming call information provided by an operating system telephony framework. The terminal detects an incoming communication, extracts identification information such as a caller number, and transmits the incoming call information to the server via the communication interface. The terminal may additionally acquire audio information of the communication using an audio stack such as an audio recording framework, and may buffer the audio information in local storage before uploading to the server. In one embodiment, the terminal executes instructions causing the terminal to record only audio from unregistered communications to reduce local storage usage and communication load.

The server compares the identification information included in incoming call information with directory information stored in the memory. When the identification information is not found in the directory information, the server determines that the communication is an unregistered communication and starts processing for fraud-risk evaluation. The server stores, in the communication history information, an entry that at least associates the identification information, a timestamp, and a flag indicating an unregistered communication.

The server acquires audio information corresponding to the unregistered communication. In one embodiment, the terminal uploads the audio information as a compressed file using an application-layer protocol such as HTTPS, and the server stores the file in a storage area accessible to the processor. The server applies audio pre-processing operations to the audio information using a multimedia processing library such as a general-purpose audio conversion framework. The server normalizes amplitude, resamples the audio to a fixed sample rate (for example, sixteen kilohertz), and converts the format to a lossless format such as a waveform-based or free lossless format. This normalization step improves the robustness and accuracy of subsequent speech recognition and reduces the computational cost of the recognition apparatus because the input format becomes uniform.

The server sends the normalized audio information to a speech recognition apparatus. In one embodiment, the speech recognition apparatus is implemented as a cloud-based speech recognition service accessible through an application programming interface, for example, a speech-to-text service. The server specifies in a recognition request configuration parameters such as language code for Japanese speech, encoding type corresponding to the audio format, and sample rate. The server receives a recognition response that includes candidate text strings with confidence scores. The server selects the text string with the highest confidence score as text data representing the audio information. The server stores the text data in association with the identification information and the corresponding unregistered communication entry in the communication history information.

The server generates a prompt sentence for a generative AI model. The server reads the stored text data and contextual information, including at least whether the communication is unregistered, a pattern of the identification information (for example, whether the number is a toll-free type), the time of day, and a duration of the communication. The server constructs a structured string in natural language that explicitly instructs the generative AI model to perform a fraud-risk analysis and to output a standardized format. For example, the server generates a prompt sentence such as:
“The following text is a transcription of a phone call from an unknown number to a user. Analyze whether this text is likely to be a fraud attempt or a legitimate commercial call.

Return a risk level (high, medium, or low) and a short explanation in Japanese.

Transcript: \“You have won a special campaign. Please provide your bank account information immediately.\””

In another embodiment, the server generates a prompt sentence emphasizing numeric scoring: “Read the following Japanese phone call transcript from an unregistered caller and assign a fraud risk score from 0 to 100, where 0 means no risk and 100 means almost certainly fraud.

Describe briefly why you assigned that score.

Transcript: \“There are outstanding tax-related fees, and you are being asked to pay immediately using electronic money.\””

The server uses stored generation conditions to decide which prompt template to use and which contextual fields to include. By expressing explicit constraints in the prompt sentence, the server forces the generative AI model to emit machine-parseable patterns that can be reliably processed by the processor, thereby reducing parsing errors and improving computational efficiency.

The server transmits the prompt sentence to the generative AI model. In one embodiment, the generative AI model is implemented as a deep neural network of a transformer architecture hosted on a remote information processing apparatus. The generative AI model includes multiple layers of self-attention and feed-forward units, trained on large corpora of textual data including examples of fraudulent and legitimate communications. The generative AI model internally represents each input token of the prompt sentence as a vector of real values, applies multi-head attention mechanisms to capture long-range dependencies between words, and computes output token probabilities through a sequence of matrix multiplications and non-linear activation functions.

The generative AI model is trained using supervised or semi-supervised learning methods. During training, the model receives training prompt sentences paired with desired outputs that classify or score the risk of fraud. The model parameters, including weight matrices and bias vectors, are updated using gradient-based optimization such as stochastic gradient descent or an adaptive moment estimation algorithm. A loss function, such as a cross-entropy loss or a mean squared error for risk scores, measures the discrepancy between predicted outputs and reference outputs. The training process performs backpropagation to propagate error gradients through all transformer layers and update the parameters to minimize the loss. In some embodiments, the model is fine-tuned on domain-specific data containing transcripts of phone-based fraud and legitimate business calls, which improves its accuracy on this particular technical task.

The server receives, from the generative AI model, a textual output representing an analysis result. The analysis result may contain explicit labels such as “high risk” and an explanatory sentence. The server parses the output using deterministic rules or regular-expression-based extraction to identify a risk level token and corresponding explanatory text. Because the server previously constrained the output format through the prompt sentence, the parsing logic becomes simpler and less error-prone than would be the case with unconstrained natural language output. The server maps textual labels such as “high” to internally defined risk levels and stores evaluation information including at least the risk level and the reason in association with the corresponding communication entry in the communication history information.

The server retrieves reference information to further refine the evaluation information. The server accesses external information resources through network requests to remote databases or web services that store reputational information about identification information. The server can retrieve, for example, the number of past reports of fraud for a given identification information value, previously observed complaint summaries, or classification tags such as “telemarketing” or “phishing.” The server can also consult the local communication history information to retrieve past evaluation information for the same identification information, including accumulated user feedback. The server combines the analysis result from the generative AI model with the reference information using a non-trivial algorithm. For instance, the server can convert the textual risk level into a numeric score, compute a weighted sum with an external spam score, and apply a non-linear mapping such as a logistic function to obtain a final risk level. The server can also apply rule-based adjustments, for example, increasing the risk level by one category if multiple users have explicitly labeled the identification information as fraudulent in the history information.

By performing this multi-source combination, the server reduces false positives and false negatives compared to systems that rely only on either a static list or a text-only model. The server uses structured representations of evaluation information and reference information, and the combination logic is executed as arithmetic operations and logical comparisons on these structured data. This processing yields a technically improved classification output that takes into account both real-time semantic analysis and accumulated empirical evidence.

The server generates warning information based on the evaluation information. The server selects a textual template according to the risk level and populates placeholders with the identification information and a shortened version of the explanatory reason. For example, when the risk level is high, the server may generate:
“Caller 0120-XXXX-XXXX is likely to be fraudulent because the caller requested immediate disclosure of bank account information as part of a supposed prize campaign. Please exercise extreme caution.”

The server sets an emphasis level for the warning information, such as using a high-priority notification, red color indication, or vibration pattern at the terminal. Because the server encodes these attributes as fields within notification data, the terminal can programmatically adjust the display format to match the risk level without needing to interpret natural language semantics.

The server transmits notification data including the warning information and related metadata to the terminal. The terminal receives the notification data through a push messaging framework and, under control of its processor, displays a visual indication on the display screen. The terminal may show a popup containing the identification information, the risk level, and a short reason. The user sees the warning and can perform a response operation or an evaluation operation, such as blocking the number, dismissing the warning, or indicating that the call was legitimate.

The terminal transmits, to the server, data representing the user operation, including the identification information, the selected action, and optionally a user comment. The server records this data as history information and updates the communication history information. The server modifies the generation conditions of the prompt sentence by, for example, adding phrases indicating that the identification information has been previously reported as fraudulent by multiple users, or by adjusting the strictness of the requested risk assessment.

The server also modifies generation conditions of the evaluation information, such as thresholds used to map numeric scores to discrete risk levels, based on aggregated user feedback.

This feedback loop constitutes a technical improvement over static systems because the server gradually shifts the decision boundaries and the prompt construction strategies in response to observed error patterns. As a result, the server can reduce misclassification rates and computational waste associated with unnecessary detailed analyses of low-risk calls. The system thus improves both accuracy and processing efficiency, by concentrating computational resources of the generative AI model on communications that exhibit ambiguous or borderline characteristics.

The server may implement alternative embodiments of the generative AI model integration. In one embodiment, the server uses a multi-stage prompt sequence where a first prompt requests only extraction of key attributes, such as “mention of prizes,” “request for payment method,” and “urgency expressions,” and a second prompt uses these structured attributes to decide the risk level. In another embodiment, the server uses a smaller, fine-tuned neural network deployed locally as a pre-filter, and only forwards more complex cases to a larger remote model. These configurations reduce network latency and computational load while maintaining or improving risk-detection performance.

The server may implement alternative architectures for the underlying neural network. In one embodiment, a bidirectional encoder is used to better understand local context in the transcript, and a classification head provides discrete risk categories. In another embodiment, a sequence-to-sequence architecture is used, where an encoder transforms the transcript into a latent vector and a decoder generates a structured textual summary including a risk level and reason. In yet another embodiment, the server uses an ensemble of models, such as a transformer model and a gradient-boosting decision tree algorithm that operates on hand-crafted features (for example, counts of imperative verbs, presence of payment-related keywords, or duration metrics). The server aggregates outputs from these models to produce the final evaluation information.

The system provides a technical effect in that the server transforms raw incoming audio into structured, machine-usable semantic and risk data using specific data structures and algorithmic flows, rather than executing a generic sequence of data acquisition and display. The server reduces network bandwidth usage by normalizing and compressing audio before speech recognition, and by selectively invoking the generative AI model only when the identification information is unregistered or when other preliminary checks indicate potential risk. The server increases fraud-detection accuracy by leveraging contextual information, explicit prompt instructions, and multi-source reference data, leading to fewer false alarms and missed detections. The server improves computational efficiency by standardizing the format of generative AI outputs, which simplifies the parsing logic and reduces the number of re-requests needed to correct malformed responses.

Because the server uses a generative AI model that has been trained with machine-learning techniques and transformer-based neural network architecture, the system applies complex statistical relationships in the text that are not easily captured by hand-crafted rules or human reasoning. The server instructs the model through carefully designed prompt sentences and converts model outputs into structured evaluation information via deterministic algorithms, thus creating a hybrid system that uses the strengths of machine-learning-based semantic understanding in combination with traditional algorithmic control. This architecture results in improved processing speed, reduced human intervention, and enhanced security of communications, constituting an improvement in computer technology rather than a mere automation of human mental judgment.

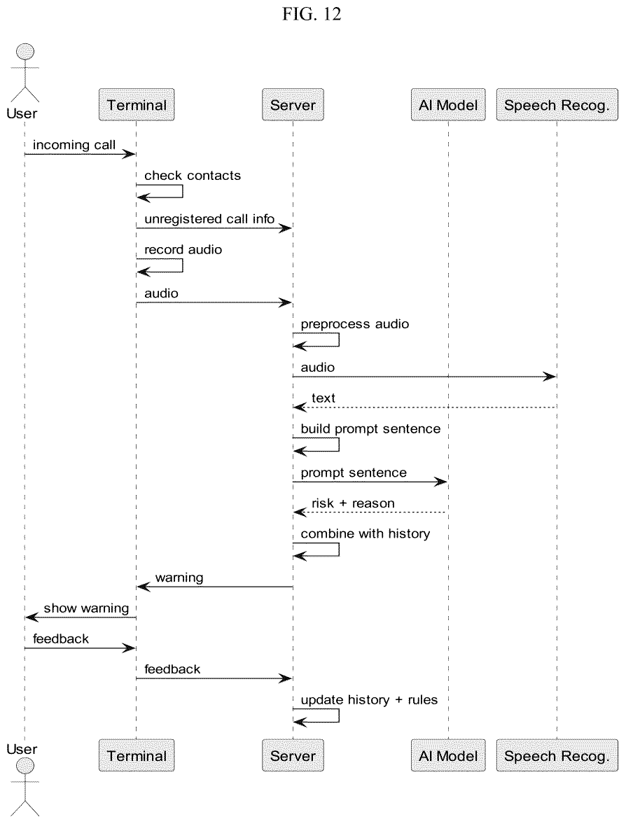

The following describes the processing flow using FIG. 12.

### Step 1

The terminal detects an incoming communication using an operating system telephony framework.

The terminal receives, as input, signaling data including a caller identification number, call state, and timestamp from the telephony subsystem.

The terminal compares the caller identification number with directory information stored in a local contact database and determines whether the number is registered.

The terminal generates, as output, incoming call information that includes the caller identification number, the call state, a timestamp, and a flag indicating that the communication is an unregistered communication when the caller identification number is not found in the directory.

The terminal transmits the incoming call information to the server via a network interface using a secure protocol.

### Step 2

The server receives the incoming call information via a communication interface.

The server takes, as input, the incoming call information including at least the caller identification number and the unregistered flag.

The server stores the incoming call information in communication history information in a memory by creating a new record that associates the caller identification number, the timestamp, and the unregistered flag.

The server outputs an updated communication history record that will be referenced in subsequent processing.

### Step 3

The terminal acquires audio information corresponding to the unregistered communication.

The terminal takes, as input, the call state from the telephony framework and an instruction or configuration specifying that audio of unregistered communications should be recorded.

The terminal activates an audio recording function using an audio input unit, encodes the captured audio into a digital format such as linear PCM at a predetermined sample rate, and writes audio frames into a buffer and then into a temporary file in local storage.

The terminal outputs an audio file path and associated metadata such as duration and format, and transmits the audio file or audio stream together with the caller identification number to the server via the communication interface.

### Step 4

The server receives the audio information from the terminal.

The server takes, as input, the uploaded audio file and associated metadata including format and sample rate.

The server performs audio pre-processing using an audio processing library, normalizing amplitude values, removing silence segments if configured, resampling to a fixed sample rate, and converting the encoding to a format suitable for a speech recognition apparatus.

The server outputs a normalized audio file stored in a storage area and an updated record in the communication history information that points to the location and parameters of the normalized audio.

### Step 5

The server converts the normalized audio information into text data using a speech recognition apparatus.

The server takes, as input, the normalized audio file and a recognition configuration that includes language code, encoding type, and sample rate.

The server sends the normalized audio to the speech recognition apparatus, receives a recognition response containing multiple candidate transcripts with confidence scores, and selects the candidate with the highest confidence score.

The server outputs text data representing the recognized content of the unregistered communication and stores the text data in association with the caller identification number in the communication history information.

### Step 6

The server generates a prompt sentence for a generative AI model based on the text data and contextual information.

The server takes, as input, the text data, the unregistered flag, the caller identification number, time-of-day information, and any previously stored evaluation information for the same caller, all retrieved from the memory.

The server selects a prompt template according to generation conditions, replaces placeholders in the template with the text data and contextual values, and concatenates these pieces into a single structured natural language string.

For example, the server may generate, as output, a prompt sentence such as: “The following text is a transcription of a phone call from an unknown number to a user. Analyze whether this text is likely to be a fraud attempt or a legitimate commercial call. Return a risk level (high, medium, or low) and a short explanation in Japanese. Transcript: \”You have won a special campaign. Please provide your bank account information immediately. \“”

### Step 7

The server sends the prompt sentence to the generative AI model executed by an information processing apparatus.

The server takes, as input, the prompt sentence and model invocation parameters such as model name, temperature, and maximum output length.

The server transmits an API request containing the prompt sentence to the information processing apparatus hosting the generative AI model, and the generative AI model processes the prompt using a transformer-based neural network to generate an analysis result.

The server receives, as output, a textual response that includes at least an explicit risk level, such as “high”, “medium”, or “low”, and an explanatory sentence.

### Step 8

The server parses the analysis result from the generative AI model to obtain structured evaluation information.

The server takes, as input, the textual response generated by the generative AI model.

The server applies predetermined parsing rules, such as regular-expression matching or delimiter-based segmentation, to extract a risk level token and a corresponding explanation string from the response.

The server maps the extracted risk level into an internal representation, for example, an integer code or enumerated value, and outputs evaluation information that combines the risk level, the explanation, and a time stamp, storing this evaluation information in association with the caller identification number and the communication record in the memory.

### Step 9

The server refines the evaluation information using reference information from external resources and local communication history.

The server takes, as input, the evaluation information from Step 8, external reputation data retrieved from remote databases about the caller identification number, and past communication history entries associated with the same caller from the memory.

The server converts textual risk labels and external scores into numeric values, performs arithmetic operations such as weighted averaging or score summation, and applies decision rules such as threshold comparisons or category escalation rules to compute a final risk level.

The server outputs updated evaluation information including the final risk level and a consolidated reason, and overwrites or extends the existing evaluation information stored in the communication history record.

### Step 10

The server generates warning information and notification data for presentation on the terminal.

The server takes, as input, the final risk level and the consolidated reason from the evaluation information, as well as the caller identification number.

The server selects a message template according to the risk level, inserts the caller identification number and a summarized reason into the template, and assigns presentation attributes such as emphasis level and display type.

The server outputs warning information and packs it into notification data that includes the warning message text, the risk level code, and the caller identification number, and transmits the notification data to the terminal via a push notification mechanism.

### Step 11

The terminal receives the notification data and presents the warning information to the user.

The terminal takes, as input, the notification data delivered by a push messaging service.

The terminal processes the data to extract the warning message text, the risk level, and the caller identification number, selects a display style based on the risk level, and renders the warning message on the display screen, for example, as a popup with highlighted color or as a banner notification.

The terminal outputs a visual indication observable by the user, and optionally triggers an audible or tactile alert corresponding to the emphasis level.

### Step 12

The user responds to the warning information and provides feedback.

The user takes, as input, the displayed warning information including the caller identification number, the risk level, and the summarized reason.

The user performs a response operation such as terminating the call, blocking the caller, or continuing the call, and may also perform an evaluation operation such as confirming that the call was fraudulent or legitimate through user interface elements.

The user's operations are output as user feedback data that includes at least the selected action, the caller identification number, and an optional comment, and this feedback data is sent by the terminal to the server.

### Step 13

The server updates history information and adjusts generation conditions based on user feedback.

The server takes, as input, the user feedback data transmitted from the terminal and the existing communication history information associated with the caller identification number.

The server writes the feedback into the history record, incrementing counters such as the number of times the caller was blocked or confirmed as fraudulent, and updates any stored label for the caller. The server then modifies the generation conditions of the prompt sentence by, for example, adding a phrase indicating that this caller has been repeatedly reported as fraudulent, or changing the requested output detail level, and adjusts evaluation thresholds used to map combined scores to risk levels.

The server outputs updated history information and revised generation conditions that will be used as input in future processing for communications from the same or similar callers, thereby refining the behavior of the system over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional communication filtering technologies, such as number-based blocking lists, heuristic rule engines, and static pattern matching on short text snippets, are insufficient to protect users from increasingly sophisticated fraudulent or otherwise harmful communications. In particular, when a communication originates from identification information that is not present in a contact record set or other registration repository, existing systems typically either treat such communications uniformly as unknown, or rely on coarse-grained rules that do not analyze the actual semantic content of the communication. As a result, users continue to be exposed to high-risk calls and messages in which malicious actors employ adaptive and natural-sounding language, psychological manipulation, and context-dependent threats that are not captured by simple rule sets or keyword filters.

Furthermore, existing architectures for fraud detection in communication systems often do not integrate automatic speech recognition and advanced natural-language analysis in a way that is robust, real-time, and adaptive. In many cases, voice content of a call is not converted into text at all, or is converted only for archival purposes, and therefore cannot be exploited effectively to perform live threat assessment. Even when textual analysis is attempted, conventional classifiers based on fixed machine learning models must be trained and redeployed periodically, and thus may fail to accommodate new fraud patterns, domain shifts, or cross-lingual variations in communication content.

In addition, current systems generally do not utilize a feedback loop in which user responses to warnings (such as hanging up, blocking a number, or confirming a suspicious communication) are systematically captured and used to refine the behavior of the analysis logic. Without such a feedback mechanism, a system cannot dynamically adjust the generation of prompts for downstream analysis models or the generation of warning messages for end users. This lack of adaptivity leads to a poor balance between false positives and false negatives, and it can result in user fatigue due to excessive or poorly targeted warnings.

There is therefore a need for a computer-implemented communication analysis system that (i) detects communications from unregistered identification information, (ii) acquires and converts voice information into character-based information by using a speech recognition component, (iii) leverages a generative information processing model via prompt sentences to perform content-sensitive fraud-risk analysis, (iv) generates and delivers context-aware warning information to a user's communication terminal in real time, and (v) continuously refines its own prompt generation and warning logic based on stored analysis results and user response information. Such a system should improve the technical functioning of communication processing by providing an integrated pipeline for acquisition, transcription, semantic analysis, decision-making, and adaptive updating of model interaction conditions, thereby enabling more accurate, timely, and user-tailored fraud detection within the communication infrastructure itself.

The specific processing by the specific processing unit 290 of the data processing device 12 in Example 2 is realized by the following means.

The present invention provides a server comprising a processor and a memory storing instructions which, when executed by the processor, cause the processor to cooperate with at least one communication terminal to (i) receive, from the communication terminal, voice information and attribute information relating to a communication connection originating from identification information that is not included in identification information managed by a registration information management unit of the communication terminal, (ii) convert or cause conversion of the voice information into character information by using a speech recognition component, (iii) generate a prompt sentence including at least the character information and one or more items of the attribute information, (iv) transmit the prompt sentence to a generative information processing model and obtain, from the generative information processing model, an analysis result including decision information and explanation information relating to a possibility of fraudulent activity, (v) compare the analysis result with past case information stored in an information storage unit to generate evaluation information relating to the possibility of fraudulent activity, (vi) generate warning information for a user on the basis of the evaluation information, and transmit the warning information to the communication terminal for immediate presentation via a user-directed display unit, and (vii) receive response-operation information from the communication terminal indicating a user-selected response operation relating to the communication connection, store the response-operation information together with the analysis result and the evaluation information in the information storage unit, and update one or more generation conditions for at least one of the prompt sentence and the warning information on the basis of information stored in the information storage unit. This enables an integrated and adaptive computer-implemented communication analysis pipeline that improves the technical operation of communication systems by automatically transcribing voice content, performing context-sensitive fraud-risk evaluation via a generative information processing model, and dynamically refining prompt and warning generation logic using feedback from stored user responses, thereby enhancing accuracy, timeliness, and relevance of fraud detection and user notification.

The term “communication terminal” refers to an electronic communication apparatus, such as a telephony device, computing device, or mobile device, that is capable of establishing a communication connection, acquiring voice information, interacting with a server over a network, and presenting information to a user.

The term “registration information management unit” refers to a logical or physical component, implemented in hardware, software, or a combination thereof, that stores and manages identification information registered in association with contacts or trusted entities, and that provides lookup functionality to determine whether identification information of an incoming communication is registered.

The term “identification information” refers to information that uniquely or semi-uniquely identifies a communication endpoint or source, including but not limited to a telephone number, network address, user identifier, or other addressing information used for establishing the communication connection.

The term “communication connection” refers to a logical or physical link established between the communication terminal and another endpoint over a communication network, the link enabling exchange of voice information, data, or signaling associated with a call or session.

The term “communication control unit” refers to a functional module that controls establishment, maintenance, and termination of the communication connection, and that monitors signaling information, including identification information, for the communication connection.

The term “voice information” refers to audio data representing spoken content transmitted or received during the communication connection, as captured by an acoustic input component and represented in an analog or digital signal form.

The term “acoustic input unit” refers to a hardware or software component, such as a microphone and associated input circuitry or drivers, configured to receive acoustic signals and convert them into electrical or digital audio signals.

The term “voice acquisition unit” refers to a functional component that controls capturing, buffering, and storing of voice information acquired from the acoustic input unit or from the communication connection.

The term “speech recognition unit” refers to a processing component, which may be local or remote, that applies speech recognition processing to the voice information to generate corresponding character information representing a textual transcription of spoken content.

The term “character information” refers to text-based data obtained by converting voice information using the speech recognition unit, the text-based data representing the semantic content of the communication connection in a machine-readable character sequence.

The term “attribute information” refers to supplemental data associated with the communication connection, including but not limited to timestamps, identification information, communication direction, duration, or other metadata descriptive of the communication context.

The term “server” refers to an information processing apparatus, typically including at least one processor and memory, that is connected to the communication terminal via a network and configured to execute data processing operations including prompt generation, model interaction, analysis, evaluation, warning generation, and information storage.

The term “prompt sentence” refers to a text string or set of text strings that include at least a portion of the character information and optionally attribute information, and that provide explicit instructions or queries to a generative information processing model regarding analysis of the communication content.

The term “generative information processing model” refers to a machine-learned model, such as a generative language model or generative AI model, configured to receive the prompt sentence as input and to generate, in response, analysis information including judgments, explanations, or structured outputs about the content of the character information.

The term “analysis result” refers to information generated by the generative information processing model in response to the prompt sentence, including at least decision information and optionally explanation information regarding the presence or absence, or degree, of fraudulent activity in the communication content.

The term “decision information” refers to a part of the analysis result that indicates a categorical or probabilistic decision, such as presence or absence of fraudulent activity, or a classification of the communication according to one or more risk categories.

The term “explanation information” refers to a part of the analysis result that describes a reason, rationale, or justification for the decision information, typically expressed in natural language or in a structured explanatory form.

The term “information storage unit” refers to a data storage component, such as a database, file system, or other persistent storage mechanism, that stores past case information, analysis results, evaluation information, response-operation information, and other related records for subsequent retrieval and processing.

The term “past case information” refers to previously stored records relating to communications, analysis results, user responses, or other events, which can be used as reference data when comparing and evaluating a current analysis result.

The term “evaluation information” refers to information generated by the server based on comparison of an analysis result with past case information, the information indicating an assessed level or likelihood of fraudulent activity for the communication connection.

The term “warning information” refers to information generated by the server and intended to alert or inform a user about a possibility or level of fraudulent activity, including content describing the risk and, optionally, recommended actions or additional explanations.

The term “notification control unit” refers to a functional component that controls transmission of the warning information from the server to the communication terminal, including formatting of notification payloads and selection of communication protocols or channels.

The term “user-directed display unit” refers to a presentation component of the communication terminal, such as a graphical user interface module, screen controller, or notification handler, that is configured to visually or otherwise perceptibly present the warning information to the user.

The term “response operation” refers to an operation selected or performed by the user in response to warning information, including but not limited to terminating the communication connection, blocking identification information, reporting the communication as fraudulent, or ignoring the warning.

The term “response-operation information” refers to data indicating which response operation was selected or performed by the user, optionally including timing, context, and associated identifiers for the communication connection.

The term “generation condition” refers to one or more parameters, rules, templates, or thresholds used by the server when generating the prompt sentence and/or the warning information, the parameters being adjustable based on stored information in the information storage unit.

The term “structured output” refers to an output format from the generative information processing model that is organized in a machine-readable structure, such as key-value pairs, lists, or other formal data structures, and that includes at least decision information, risk level information, and explanation information.

The term “truth-value information” refers to a portion of the structured output that indicates, using a boolean or equivalent representation, whether the communication is determined to correspond to fraudulent activity.

The term “level information” refers to a portion of the structured output that indicates a degree or category of risk, such as low, medium, or high, associated with the communication.

The term “importance level” refers to an attribute of the warning information that indicates priority or urgency for presentation to the user, and that may influence notification timing, prominence, or display modality.

The term “presentation mode” refers to a manner or format in which the warning information is presented to the user, including but not limited to pop-up alerts, banners, in-call overlays, or other interface elements on the communication terminal.

In one embodiment, a server cooperates with at least one terminal to implement a communication analysis system that evaluates a possibility of fraudulent activity in real-time communications originating from unregistered identification information. The server includes at least one processor, a main memory, a non-volatile storage device, and a network interface. The terminal includes a processor, a memory, a microphone, an audio subsystem, a display, and a network interface. The server and the terminal exchange data via a communication network such as a packet-switched network.

The terminal executes communication control software that interfaces with a telephony stack or a voice-over-network stack. The terminal manages a registration information management unit implemented as a contacts database or a similar data structure stored in non-volatile memory. The terminal compares identification information of an incoming communication, such as a telephone number or a network address, with entries in this registration information management unit. The terminal identifies a communication as originating from unregistered identification information when the identification information is not present in the registration information management unit.

The terminal acquires voice information associated with the communication by using an acoustic input unit implemented as a microphone and audio driver circuitry. The terminal uses a voice acquisition unit implemented in software (for example, a recording module using an operating-system audio API) to sample the analog acoustic signal at a given sampling rate, such as 16 kHz, and to convert the sampled signal into digital audio data. The terminal stores the digital audio data in a buffer in main memory and optionally writes segments of the data to a file in local storage. The terminal associates the digital audio data with attribute information such as a timestamp, communication identifier, identification information of the opposite endpoint, direction of communication, and language code.

In some embodiments, the terminal performs speech recognition locally by using a speech recognition unit implemented as a neural-network-based acoustic model and a language model executed on the terminal processor. In other embodiments, the terminal transmits the digital audio data and the attribute information to the server, and the server performs the speech recognition. For example, the server uses speech recognition software equivalent to cloud-based speech-to-text technology, which includes a deep neural network acoustic model (such as a multi-layer convolutional or recurrent model) and a probabilistic language model (such as an n-gram model or a transformer-based decoder). The server extracts acoustic features such as Mel-frequency cepstral coefficients (MFCCs) or log-mel spectrograms from the digital audio data, feeds the features into the acoustic model, and decodes the most probable sequence of linguistic units by maximizing a combined score of acoustic and language probabilities. The server outputs character information as a sequence of characters or tokens representing a transcription of the voice information.

The server stores the character information and the associated attribute information in an information storage unit implemented as a relational database, key-value store, or document-oriented store. The server assigns a unique identifier to each transcription record and maintains indices based on identification information, timestamps, and risk-related fields to optimize subsequent retrieval and comparison. The server normalizes the character information by performing operations such as lowercasing, removal of non-speech markers, punctuation normalization, and language-specific tokenization.

The server generates a prompt sentence that includes the character information and at least part of the attribute information. The server builds the prompt sentence according to a template stored in a configuration repository. In one example, the server generates the following prompt sentence:
“Here is the transcript of a phone call from an unregistered number:
‘[TRANSCRIPT TEXT]’
Does this phone call have a possibility of being a scam? Answer in English with ‘Yes’ or ‘No’ and briefly explain why.”

In another example, the server generates a prompt sentence instructing a structured analysis:
“You are a fraud-detection assistant analyzing phone call transcripts. Evaluate whether the following phone call content has a possibility of being a scam.

Transcript:
‘[TRANSCRIPT TEXT]’
Output in English with the following fields:
is_scam: true or false
risk_level: one of [low, medium, high]
reason: short explanation of the judgment.”

The server inputs the prompt sentence into a generative AI model implemented as a transformer-based generative information processing model. The generative AI model includes multiple layers of self-attention and feed-forward sublayers, positional encodings, and layer normalization. The generative AI model operates on tokenized representations of the prompt sentence, where the server converts the prompt text into token IDs using a tokenizer such as a byte-pair-encoding or unigram language model. The server sends the token IDs and model parameters such as temperature, maximum output length, and sampling strategy (for example, top-k or nucleus sampling) to the generative AI model.

In one implementation, the generative AI model has been pre-trained on large-scale text corpora using an unsupervised or self-supervised objective, such as next-token prediction. The model parameters (weights of attention matrices and feed-forward layers) are optimized during pre-training using stochastic gradient descent or a variant thereof, such as Adam, with a loss function that minimizes cross-entropy between predicted token distributions and ground-truth tokens. Fine-tuning on domain-specific datasets containing examples of fraudulent and non-fraudulent communications can be performed using supervised learning, where the training data includes labels indicating scam patterns, risk levels, and explanation phrases. During fine-tuning, the server or a training environment updates subsets of the model weights to minimize a combined loss function that includes classification loss and explanation consistency loss.

The server obtains an analysis result from the generative AI model. The analysis result includes at least decision information (for example, “Yes, this is likely a scam” or “No, this is unlikely to be a scam”) and explanation information (for example, “The caller demands immediate payment and threatens legal action if payment is not made, which is a typical scam pattern.”). In structured-output embodiments, the analysis result includes fields such as “is_scam: true,” “risk_level: high,” and “reason: urgent legal threats and request for financial data.” The server parses the textual output or structured fields using pattern-matching and parsing logic, and stores the parsed analysis result in the information storage unit along with the original character information and attribute information.

The server compares the analysis result with past case information stored in the information storage unit. The past case information includes previous communication records, corresponding analysis results, and user response-operation information. The server uses similarity metrics, such as cosine similarity over vector embeddings of character information, or hash-based lookups on normalized phrases, to identify patterns of fraud consistent with past confirmed scam calls. The server may compute an evaluation score by aggregating the analysis result from the generative AI model with historical statistics, such as false-positive and false-negative rates observed for similar content. The server generates evaluation information that quantifies the probability or severity of fraudulent activity for the current communication, for example as a numerical risk score or a categorical label.

The server generates warning information based on the evaluation information. The server determines an importance level and presentation mode for the warning, taking into account the risk level, the user's prior interactions, and device capabilities. The server builds a warning message in natural language, for example:
“There is a possibility of fraudulent activity in this call. The caller requested immediate payment and bank account information, which are typical signs of a scam. Do not provide personal or financial information.”

The server encapsulates the warning information and associated metadata (such as the communication identifier and risk level) in a notification payload and transmits the payload to the terminal via a notification control unit. The notification control unit interfaces with a push-notification service or a persistent network channel and applies transmission protocols that minimize latency while respecting bandwidth constraints.

The terminal receives the notification payload and validates its integrity and origin. The terminal uses a user-directed display unit implemented as a display controller and a graphical user interface module to present the warning information. The terminal may display the warning as an in-call overlay, a pop-up dialog, or a notification banner, and may adjust color, size, and priority based on the importance level. The terminal can disable certain user interface actions, such as tapping on links in a suspicious message, until the user acknowledges the warning.

The user views the warning information on the terminal display. The user can select a response operation, such as terminating the communication connection, blocking future communications from the same identification information, or reporting the communication as confirmed fraud. The terminal captures the response-operation information in a structured format that includes the type of operation, a timestamp, and the associated communication identifier.

The terminal transmits the response-operation information to the server. The server stores the response-operation information in the information storage unit together with the character information, attribute information, and analysis result. The server uses this feedback to update one or more generation conditions for subsequent prompt sentences and warning information. For example, the server may adjust the threshold risk level required to trigger a high-priority warning, modify the wording or structure of the prompt sentence to elicit more reliable structured outputs from the generative AI model, or refine the mapping between model output and user-visible warning categories.

The server can implement this updating process using algorithms that monitor performance metrics such as precision, recall, and user-confirmed fraud rates over time. The server can adjust weights applied to different features of the analysis result (for instance, certain linguistic patterns or risk markers) and can modify rule-based post-processing logic that interprets the generative AI model's output. The server can also maintain different prompt templates for different languages or communication contexts and can select a template based on attribute information, thereby improving multilingual coverage and domain adaptation.

The server improves computer-implemented communication analysis by using specific data structures and algorithms. The server represents each communication as a record linking audio identifiers, transcription text, model output, evaluation score, and user feedback. By maintaining this structured linkage, the server enables efficient queries that compute historical patterns, reduces redundant analysis, and supports caching of model outputs for repeated similar content, which reduces computational load and network usage. The server also applies batching strategies when sending prompt sentences to the generative AI model, thereby increasing throughput and reducing per-request overhead.

The system achieves technical effects beyond mere automation of human review. The server performs real-time transcription and generative-model-based semantic analysis on raw audio signals, which would be impractical for a human to do at scale or with the same speed. The server exploits parallelizable vector operations on specialized hardware (such as graphics processing units or tensor accelerators) to process high volumes of communication content with low latency. By converting voice information into machine-readable character information and then into structured risk descriptors, the server enables automated, fine-grained control over warning generation and device behavior, reducing false positive and false negative rates compared with prior rule-based or human-only systems.

The use of a generative AI model with explicitly designed prompt sentences allows the server to dynamically adapt to novel scam patterns without re-engineering fixed classifiers. The model uses internal attention mechanisms to relate distant parts of a transcript, enabling detection of nuanced scam tactics that depend on context across multiple utterances. This context-sensitive capability improves detection accuracy and reduces the computational cost of hand-crafted feature engineering. The server's feedback-based adjustment of generation conditions introduces a non-conventional control loop that aligns model interaction parameters with observed system performance, thereby improving the functioning of the computer system itself rather than merely implementing a business policy.

In alternative embodiments, the terminal can perform some or all of the generative AI analysis locally, using an on-device model with a reduced parameter size but a similar transformer architecture. In such cases, the terminal stores a compressed version of the generative AI model and executes inference using hardware acceleration available on the device. This reduces network bandwidth consumption and latency, improving user experience and robustness in environments with limited connectivity. The server can still receive periodic summaries or anonymized statistics from the terminal to update global generation conditions.

In other embodiments, the server can integrate additional model architectures, such as hierarchical transformers for long transcripts or hybrid models combining rule-based filters with generative-model judgments. The server may run an initial lightweight classifier to filter out clearly benign communications and reserve generative-model analysis for ambiguous or high-risk cases, thereby improving computation efficiency and scaling to large traffic volumes. The server may also store intermediate feature representations, such as vector embeddings, to reuse past computations and further reduce processing time.

By integrating the terminal's communication control, the audio acquisition and transcription pipeline, the generative AI model interaction via prompt sentences, and the feedback-driven update of prompt and warning generation conditions, the system provides a concrete and technical solution to the problem of detecting fraudulent communications from unregistered identification information. The cooperation between the server and the terminal results in improved accuracy, faster response, reduced network and computation overhead, and more effective protection for users within the communication infrastructure.

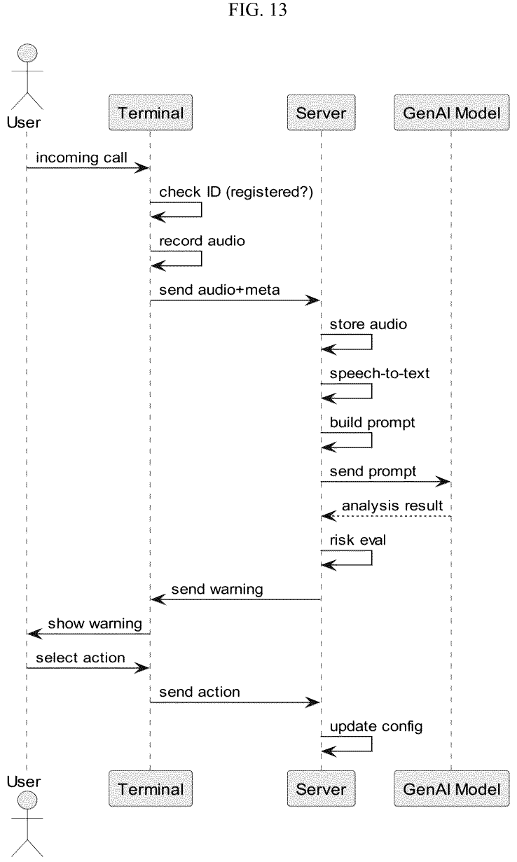

The following describes the processing flow using FIG. 13.

### Step 1

The terminal monitors incoming communication requests through its communication control unit. The input to this step is signaling information from a network stack, including identification information such as a caller number or network address. The terminal compares this identification information with registration data stored in a registration information management unit (for example, a contacts database). Based on this comparison, the terminal classifies the communication as originating from registered or unregistered identification information. The output of this step is a classification result and associated attribute information (including timestamp, identification information, and communication direction) that indicate whether the communication is from an unregistered source.

### Step 2

The terminal acquires voice information for a communication that has been classified as originating from unregistered identification information. The input to this step is the classification result from Step 1 and the live audio stream from the acoustic input unit (microphone) and audio subsystem. The terminal uses a voice acquisition unit to sample the analog audio signal, digitize it into a digital audio stream (for example, 16 kHz, 16-bit PCM), and buffer the stream in memory. The terminal segments the stream into audio frames or files and attaches attribute information (such as communication identifier, timestamp, and identification information). The output of this step is structured voice information in digital form, linked with its attribute information.

### Step 3

The terminal transmits the voice information and attribute information to the server. The input to this step is the structured voice information and attribute information from Step 2. The terminal packages the audio data and metadata into a request message and sends the message to the server via a secure network protocol (for example, HTTPS). The terminal may compress the audio data or encode it in a standard audio container format to reduce network load. The output of this step is a received request at the server side containing the voice information and associated attribute information.

### Step 4

The server receives and stores the voice information and attribute information. The input to this step is the request message transmitted from the terminal in Step 3. The server validates the request, extracts the audio payload and metadata, and writes the audio data to a temporary storage area while storing the metadata in an information storage unit. The server assigns a unique communication record identifier and links the audio storage location with the identifier. The output of this step is a stored audio record and a corresponding metadata record ready for transcription.

### Step 5

The server converts the voice information into character information using a speech recognition unit. The input to this step is the stored audio record and its associated metadata (including language code if available). The server performs feature extraction on the audio signal (for example, computing Mel-frequency cepstral coefficients or log-mel spectrograms), feeds these features into a trained acoustic model and language model, and decodes the most probable sequence of words or characters. The server combines acoustic and language probabilities to maximize a decoding score. The output of this step is character information in the form of a text transcript that represents the content of the communication.

### Step 6

The server normalizes and stores the character information together with the attribute information. The input to this step is the raw transcription output from Step 5 and the existing metadata for the communication record. The server performs text normalization operations such as lowercasing, punctuation normalization, removal of non-speech tags, and language-appropriate tokenization. The server updates the communication record in the information storage unit to include the normalized character information, linked via the communication record identifier. The output of this step is a fully updated communication record containing both normalized character information and attribute information.

### Step 7

The server generates a prompt sentence for a generative AI model based on the character information and attribute information. The input to this step is the normalized character information and associated metadata from Step 6. The server selects an appropriate prompt template from a configuration repository, inserts the transcript and, optionally, contextual attributes (such as “this is a call from an unregistered number”), and constructs a textual prompt sentence. For example, the server can generate:
“Here is the transcript of a phone call from an unregistered number:
‘[TRANSCRIPT TEXT]’
Does this phone call have a possibility of being a scam? Answer in English with ‘Yes’ or ‘No’ and briefly explain why.”

The output of this step is a completed prompt sentence string ready for tokenization and model input.

### Step 8

The server tokenizes the prompt sentence and sends it to a generative AI model for analysis. The input to this step is the prompt sentence from Step 7. The server passes the prompt sentence through a tokenizer (for example, a byte-pair encoding tokenizer) to convert it into a sequence of token identifiers. The server then sends these token identifiers and model configuration parameters (such as temperature, maximum output tokens, and decoding strategy) to a transformer-based generative AI model via an API or local model inference engine. Inside the model, attention layers compute contextualized embeddings for each token, and feed-forward layers transform these embeddings to predict output tokens that represent an analysis of the prompt. The output of this step is a generated response text from the generative AI model.

### Step 9

The server parses the response from the generative AI model to obtain analysis result information. The input to this step is the response text produced in Step 8. The server applies parsing logic (for example, pattern matching, keyword detection, or structured field extraction) to identify decision information such as “Yes” or “No” for scam likelihood and explanation information describing the reasoning. In structured-prompt embodiments, the server extracts fields such as “is_scam,” “risk_level,” and “reason” from the model output. The server stores this analysis result in the information storage unit, linked to the communication record. The output of this step is structured analysis result information associated with the communication.

### Step 10

The server evaluates the risk of fraudulent activity by comparing the analysis result with past case information. The input to this step is the analysis result from Step 9 and past case information stored in the information storage unit (including previous transcripts, risk labels, and user-confirmed fraud records). The server computes similarity measures between the current character information and past character information, aggregates historical performance metrics for similar cases, and combines these with the current model decision. The server may use scoring rules or a secondary classifier to convert this combined information into an evaluation score or categorical risk level. The output of this step is evaluation information indicating the assessed probability or risk level of fraudulent activity for the communication.

### Step 11

The server generates warning information for the user based on the evaluation information. The input to this step is the evaluation information from Step 10 and the analysis result from Step 9. The server determines an importance level and selects wording for a user-facing warning message according to predefined rules and configurable templates. The server assembles warning content that includes a concise risk statement, an explanation, and optional recommended actions. For example, the server may generate:
“There is a possibility of fraudulent activity in this call. The caller requested immediate payment and personal financial information, which are typical signs of a scam.”

The output of this step is structured warning information, including message text, importance level, and reference identifiers for the communication.

### Step 12

The server transmits the warning information to the terminal. The input to this step is the warning information from Step 11 and the communication identifier. The server formats the warning information into a notification payload and uses a notification control unit to send the payload through a push notification service or a persistent communication channel to the terminal that is handling the communication. The server sets appropriate flags (such as high priority) in the payload header to ensure timely delivery. The output of this step is a notification message received at the terminal side.

### Step 13

The terminal receives and displays the warning information to the user. The input to this step is the notification payload from Step 12. The terminal verifies the authenticity of the payload, extracts the warning text, importance level, and communication identifier, and invokes a user-directed display unit to render the warning. The terminal overlays the warning on the current call screen, shows a pop-up message, or displays a banner, possibly with visual emphasis depending on the importance level. The output of this step is a visible warning message presented to the user on the terminal display.

### Step 14

The user selects a response operation in view of the warning information. The input to this step is the displayed warning message and any available response controls on the terminal user interface (for example, buttons for “End call,” “Block number,” or “Report scam”). The user interprets the warning and taps or otherwise selects one of the offered response operations. The output of this step is user input indicating the chosen response operation.

### Step 15

The terminal generates and transmits response-operation information to the server. The input to this step is the user's selected response operation from Step 14 and the current communication context (including the communication identifier and identification information). The terminal packages the response type, timestamp, and context into structured response-operation information and sends this information to the server over the network. The output of this step is a received response-operation record on the server side.

### Step 16

The server stores the response-operation information and updates generation conditions for subsequent processing. The input to this step is the response-operation information from Step 15, along with the existing communication record, analysis result, and evaluation information stored in the information storage unit. The server writes the response-operation information into the corresponding communication record and updates aggregated statistics and performance metrics (such as the rate at which high-risk warnings are confirmed by user actions). Based on these updated metrics, the server adjusts generation conditions for prompt sentences (for example, modifying templates, adding clarifying instructions, or changing threshold criteria) and for warning information (for example, raising or lowering the risk score required for a high-priority warning). The output of this step is an updated configuration for prompt generation and warning generation, which influences the processing of future communications and improves overall detection performance.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional communication screening systems that rely on static rules, signature lists, or simple keyword matching are increasingly ineffective in detecting fraudulent or abusive communications originating from identification information that is not registered in a user's address database. Such systems primarily perform one-directional filtering at the network edge or on a device, without deeply analyzing the semantic content of call audio or dynamically adapting their behavior to the user's current state. As a result, these systems often fail to recognize newly emerging fraud patterns, generate excessive false positives that desensitize users, and provide warnings that are too generic or poorly timed to be actionable, especially for vulnerable users such as elderly persons.

From a computer-technology standpoint, existing architectures treat speech recognition, content analysis, and user interface notification as loosely coupled subsystems. Speech-to-text engines typically output transcripts that are consumed by simple classifiers, and warning messages are generated by fixed templates that do not incorporate higher-level natural language reasoning or real-time user context. This separation results in inefficient use of computational resources, limited adaptability to new attack vectors, and an inability to provide fine-grained risk evaluation. Furthermore, conventional systems do not integrate generative natural language models into the core execution pipeline; instead, they rely on pre-trained discriminative models with narrow label sets, which lack the flexibility to synthesize context-appropriate warnings or to explain the basis of a risk judgment.

Another technical deficiency is that known systems do not treat user emotional state as a first-class input to the computation of warning content and presentation format. Audio pipelines on client devices or servers may discard prosodic and paralinguistic features after transcription, and user interfaces typically present warnings in a single static style regardless of whether the user is calm, confused, or fearful. This leads to suboptimal human-computer interaction: warnings may be too weak to interrupt dangerous behavior for an anxious user, or too intrusive and disruptive for a calm user in a low-risk situation. There is therefore a need for an improved computer-implemented system in which detection of unregistered communications, semantic risk analysis by a generative AI model, comparison with case information resources, and estimation of user emotion are integrated into a coordinated processing pipeline that dynamically adjusts both the content and the modality of warnings.

Accordingly, a technical problem to be solved by the present invention is to provide an improved information processing architecture and control logic that: (i) automatically detects communications from unregistered identification information; (ii) converts audio information of such communications into text data; (iii) leverages a generative AI model via a prompt sentence to perform deep semantic analysis; (iv) combines the model's analysis with case information stored in an information resource to compute risk evaluation information; and (v) estimates user emotional state and uses it in real time to adapt the warning information and its presentation format. By solving this problem, the invention aims to improve the accuracy, responsiveness, and contextual relevance of fraud-related warnings at the system level, thereby enhancing the overall functioning of the computer system itself, rather than merely automating a human mental process.

The specific processing by the specific processing unit 290 of the data processing device 12 in Application Example 2 is realized by the following means.

The present invention provides a server comprising a processor configured to detect communication from identification information that is not registered in an address database, to acquire audio information related to the communication and convert the audio information into text data by using a speech recognition technique, to generate a prompt sentence that instructs analysis of the text data and input the prompt sentence to a generative AI model to obtain analysis result information, to compare the analysis result information with case information recorded in an information resource to generate risk evaluation information relating to at least one of improper activity and solicitation activity, to estimate an emotional state of a user based on at least one of user audio information and user text data acquired during the communication, to dynamically adjust content and presentation format of warning information according to the emotional state and the risk evaluation information, and to notify the adjusted warning information to the user via a user interface. This enables the server to implement an integrated, computer-centric processing pipeline in which unregistered communications are semantically analyzed by a generative AI model under explicit prompt control, correlated with case information resources to compute a refined risk evaluation, and combined with real-time user emotion estimation so that the server can automatically generate and deliver context-adaptive warning information, thereby improving the technical performance of fraud detection, warning accuracy, and user-interface control within the communication processing system.

The term “communication” refers to an exchange of information between terminals or devices, including at least voice calls and may further include data transmission, signaling, or other forms of electronic interaction over a communication network.

The term “identification information” refers to information used to distinguish one communication source or destination from another, including at least a telephone number and may further include a network address, a subscriber identifier, or any other unique or pseudo-unique identifier associated with a communication endpoint.

The term “address database” refers to a data structure stored in a memory of a device or server that maintains association records between identification information and contact entries, including at least a list of identifiers and corresponding names, and may further include additional attributes such as categories, notes, or blocking flags.

The term “unregistered identification information” refers to identification information associated with a communication that does not correspond to any entry stored in the address database at the time the communication is detected.

The term “audio information” refers to digital or analog representations of sound acquired during a communication, including at least speech signals produced by a caller or a user, and may further include background sounds, tones, or other acoustic events.

The term “speech recognition technique” refers to a computer-implemented processing method that receives audio information as input and outputs corresponding text data, including at least automatic speech recognition algorithms and may further include preprocessing, acoustic modeling, and language modeling.

The term “text data” refers to information expressed as a sequence of characters or symbols that represent linguistic content derived from audio information or other sources, suitable for further analysis by natural language processing or other algorithms.

The term “prompt sentence” refers to a text expression that instructs a generative AI model to perform a specified analysis or generation task on input data, including at least natural language directions and may further include constraints, output formats, or contextual information.

The term “generative AI model” refers to an information processing model implemented by software and hardware that receives a prompt sentence and optionally additional input data, and generates output information by producing new text or structured data using machine learning, including at least a generative language model based on neural network techniques.

The term “analysis result information” refers to information output by the generative AI model in response to a prompt sentence, including at least a classification, explanation, or evaluation of input text data, and may further include confidence values, recommended actions, or extracted features.

The term “information resource” refers to a storage system accessible by the processor that maintains case information or reference data used for comparison with analysis result information, including at least a database of past events or patterns and may further include external data sources obtained over a network.

The term “case information” refers to records stored in the information resource that describe past occurrences of improper activity, solicitation activity, or other relevant events, including at least textual descriptions and may further include associated metadata such as risk levels or pattern identifiers.

The term “risk evaluation information” refers to information indicating a likelihood or severity of at least one of improper activity and solicitation activity for a communication, including at least a categorical label or numerical score and may further include explanatory data.

The term “improper activity” refers to an activity associated with a communication that is undesirable or harmful to a user, including at least fraudulent behavior, unauthorized access attempts, or deceptive practices.

The term “solicitation activity” refers to an activity associated with a communication that attempts to induce a user to purchase goods or services or to engage in a transaction, including at least sales calls and may further include aggressive marketing or unsolicited offers.

The term “warning information” refers to information generated by the processor to notify a user of a detected risk, including at least a warning message and may further include risk levels, recommended actions, or explanatory content.

The term “emotional state” refers to a psychological condition of a user at a given time, estimated by analysis of user audio information or user text data, including at least states such as calmness, anxiety, fear, or confusion.

The term “user audio information” refers to audio information that is attributable to the user, including at least voice signals produced by the user during a communication.

The term “user text data” refers to text data that represents utterances or inputs made by the user, including at least transcripts of user speech and may further include typed text or other textual input.

The term “content of warning information” refers to linguistic or symbolic elements included in warning information, including at least an alert phrase or message body and may further include summarized reasons or risk indicators.

The term “presentation format” refers to a manner in which warning information is output to the user through a user interface, including at least properties such as character size, color, display location, and may further include vibration pattern, sound pattern, or timing.

The term “dynamically adjust” refers to modifying at runtime one or more parameters related to content or presentation format of warning information in response to changing inputs, including at least the emotional state and the risk evaluation information.

The term “user interface” refers to hardware and software elements that enable interaction between the system and the user, including at least a display device and an input device, and may further include a touch panel, a speaker, or a vibration actuator.

The term “notify the adjusted warning information” refers to causing the adjusted warning information to be output to the user via the user interface, including at least presenting visual elements and may further include generating tactile or audio feedback.

In one embodiment, a server cooperates with one or more terminals to implement a system that detects communication from unregistered identification information, performs semantic and contextual risk analysis using a generative AI model in response to a prompt sentence, evaluates a user emotional state, and generates warning information whose content and presentation format are dynamically adjusted. A user interacts with the system through the terminals, which operate as communication devices such as smartphones or other network-connected apparatuses.

A server includes at least one processor, a main memory, a non-volatile storage device, a network interface, and optionally a hardware accelerator such as a graphics processing unit or a tensor processing unit. The server executes an operating system and application programs including a speech-to-text module, a generative AI interface module, a case-database matching module, an emotion-estimation module, and a warning-generation and user-interface control module. In one concrete example, the server uses a cloud-based speech recognition service such as a generic speech-to-text API, a database engine such as a relational database management system, and a generative AI model implemented as a transformer-based neural network.

A terminal includes at least one processor, a memory, a radio communication unit, an audio input unit, an audio output unit, a display, a vibration actuator, and an input device such as a touch panel. The terminal executes an operating system, a telephony framework, and a client application program that communicates with the server. The client application program manages a local address database, which may be implemented as a structured storage (for example, a contact list stored in a relational or key-value database) mapping identification information such as phone numbers to contact entries.

A terminal detects communication from identification information that is not registered in the address database by comparing a communication identifier contained in an incoming call or message with the contact entries. The terminal reads the identifier via the telephony framework, performs a lookup against the address database, and determines that the identification information is unregistered when no matching entry exists. The terminal then initiates acquisition of audio information associated with the communication. In one form, the terminal acquires audio information of a voice call through an audio capture subsystem that digitizes the signal into linear pulse-code modulated samples.

A server receives the audio information from the terminal through the network interface. The server applies a speech recognition technique that includes at least pre-emphasis, framing, windowing, feature extraction, and decoding. The server may compute feature vectors such as mel-frequency cepstral coefficients, pass them through an acoustic model implemented by a deep neural network, and apply a language model to generate text data representing the recognized linguistic content. In one implementation, the server uses a cloud speech-to-text service that internally performs similar operations and returns a sequence of tokens forming text data in a designated language.

A server generates a prompt sentence for a generative AI model using the text data. The server constructs the prompt sentence as a natural-language instruction that describes a required analysis task, a desired output format, and the text data as context. The server can embed control tokens or special phrases that guide the generative AI model to produce a structured and machine-parsable answer. For example, the server may generate a prompt sentence expressed as:
“You are a fraud detection assistant. Analyze the following call transcript from an unregistered phone number and determine: (1) whether this call is likely to be a fraudulent or improper activity, classified as LOW, MEDIUM, or HIGH risk, and (2) a short warning message appropriate for an elderly user. Transcript: ‘Your bank account is in danger. You must transfer your money to a safe account immediately.’ Answer concisely.”

In another example, the server may generate a prompt sentence expressed as:
“You are analyzing a call from an unknown caller. Classify whether the following transcript indicates improper activity, solicitation activity, or neither. Then propose a brief warning sentence that can be displayed to the user. Transcript: ‘Would you like to purchase a new insurance product today? It is very advantageous.’”

A server inputs the prompt sentence and the associated text data to a generative AI model. The generative AI model is implemented as a multi-layer neural network, for example a transformer architecture having multiple encoder-decoder layers, attention mechanisms, and position-encoding components. The model receives tokenized representations of the prompt sentence and the transcript. The server applies an embedding layer to map tokens to numerical vectors, processes the vectors through stacked self-attention and feed-forward layers, and computes a probability distribution over output tokens at each generation step. The server configures model parameters such as a temperature parameter, a maximum output length, and a nucleus sampling parameter, thereby controlling the determinism and diversity of generated analysis result information.

The server trains or fine-tunes the generative AI model on corpora including labeled examples of fraudulent, improper, and solicitation communications. During training, the server minimizes a loss function such as a cross-entropy loss between predicted token distributions and ground-truth target sequences. The server iteratively updates network weights using an optimization algorithm such as stochastic gradient descent or an adaptive variant. In some embodiments, the server augments training data by paraphrasing original transcripts and synthesizing additional negative and positive examples, thereby increasing robustness of the model to linguistic variations.

By including explicit labels or structured segments in training targets, the server enables the generative AI model to output analysis result information that contains, for example, a classification label (“HIGH”), a numerical risk score, and a reasoned explanation. The server can enforce structure by instructing the model to output fixed markers such as “Risk:”, “Category:”, and “SuggestedWarning:”. Such structured analysis result information improves downstream parsing, reduces post-processing complexity, and enhances computational efficiency compared with unstructured text analysis.

A server compares the analysis result information with case information stored in an information resource. The information resource may be implemented as a relational database, a document store, or a graph database containing records that describe known patterns of improper and solicitation activity. Each record can include attributes such as representative phrases, contextual conditions, prior risk scores, and statistical frequency. The server derives additional feature vectors from the text data, such as term-frequency vectors, embeddings from the generative AI model, or other semantic representations. The server then executes a similarity search between the current communication's features and case information features, using algorithms such as cosine similarity, locality-sensitive hashing, or k-nearest-neighbor search.

By merging the similarity scores with the generative AI model's risk indication, the server obtains risk evaluation information that is more accurate and stable than an evaluation based only on either rule-based matching or model output. For example, when the analysis result information indicates a medium risk but highly similar case information corresponds to known high-risk fraudulent schemes, the server adjusts the risk evaluation information upward to a high-risk category. This hybrid approach improves detection accuracy and reduces false negatives, thus representing a technical improvement in classification performance of the computer system.

A terminal or the server estimates a user emotional state from user audio information or user text data. The terminal can separate user audio information from other audio streams based on directionality, timing, or channel assignment. The server computes acoustic features such as pitch, energy, spectral centroid, and temporal statistics. Additionally, the server can analyze user text data obtained from speech recognition of user utterances. The server then applies an emotion-estimation model, which can be realized as a neural network classifier trained on labeled emotional speech corpora. The classifier may output probability values for categories such as calm, anxious, fearful, and confused.

The server uses the emotional state together with the risk evaluation information to generate warning information. The server assembles warning information as a data structure including at least a message string, a risk level indicator, and presentation parameters. The presentation parameters can define character size, color, position on the display, and vibration intensity or pattern. For instance, when the emotional state is fearful and the risk evaluation information indicates high risk, the server sets a larger character size, a high-contrast color such as red, and a strong vibration pattern for the warning information. Conversely, when the user is calm and the risk evaluation information is low, the server may select a more moderate presentation that reduces distraction and conserves terminal resources.

A terminal receives the warning information from the server via the network interface and applies the presentation parameters to output the warning information through a user interface. The terminal controls a display controller to render the message string at a specified size and color, activates a vibration actuator according to the vibration pattern, and may optionally use an audio output unit to generate an alert sound. As a technical consequence, the warning information is not only contextually appropriate in its content but also optimized in its modality, thus improving human-machine interaction and minimizing unnecessary cognitive load.

The described configuration provides several technical effects that go beyond a mere automation of human judgment. First, by integrating the generative AI model through the prompt sentence with case-database matching, the server reduces the computational overhead associated with separate, redundant rule engines. The generative AI model can compress complex natural-language inference into a single inference pass, and the server's post-processing and database matching operate on structured analysis result information instead of on raw text, thereby reducing parsing cost and memory usage. This leads to improvements in processing latency and throughput when analyzing multiple parallel communications.

Second, by tightly coupling emotion estimation with warning generation at the processor level, the system reduces the number of unnecessary or overly intrusive alerts, which would otherwise waste display and vibration resources and contribute to alert fatigue. The server can schedule fewer high-intensity notifications by accurately identifying when the user actually needs a strong warning. This targeted control of interface resources represents a practical enhancement of device-level resource management and user-interface performance.

Third, the server introduces non-conventional rule combinations that are difficult for a human operator to apply consistently, such as combining a generative AI model's confidence scores, similarity metrics to case information, and emotional state weights in a unified risk scoring function. In one example, the server may compute a composite score by taking a weighted sum or non-linear function of the generative AI risk probability, the nearest-neighbor similarity score, and an emotional amplification factor that increases sensitivity when the user appears vulnerable. This composite algorithm, implemented in the processor, results in a more discriminative decision boundary, thereby reducing both false positives and false negatives, and constitutes an improvement of the computer's decision-making capability as a technical system.

Fourth, by designing the generative AI model architecture and training procedure to output structured risk and explanation fields in response to a constrained prompt sentence, the server improves explainability and traceability of automated decisions. This reduces the need for additional post-hoc explanation modules and allows the system to log concise reasoning together with risk decisions, optimizing storage utilization and facilitating efficient later retrieval and audit. The ability to retrieve concise structured explanations accelerates subsequent machine-learning refinement and leads to faster convergence of retrained models.

The system is not limited to a single implementation. In an alternative embodiment, the terminal performs the speech recognition locally using an embedded speech-to-text module and sends only the text data to the server, thereby reducing uplink bandwidth consumption and improving privacy. In another embodiment, the terminal hosts a compact generative AI model executed by a local hardware accelerator, and the server mainly manages case information and coordination among multiple terminals. In yet another embodiment, the emotion-estimation model executes entirely on the terminal, using sensor data local to the device, while the server focuses on intensive generative analysis and database operations.

A user employs the system by using a terminal as usual for communication. When the user receives a voice call from an unknown number, the terminal and server automatically cooperate as described to assess risk and user emotional state. The user receives warning information whose content and presentation have been adapted specifically to that situation. As a result, the user can make informed decisions more efficiently, while the terminal and server perform a series of technically specialized operations that improve detection speed, analytical accuracy, resource management, and overall communication security at the computer-system level.

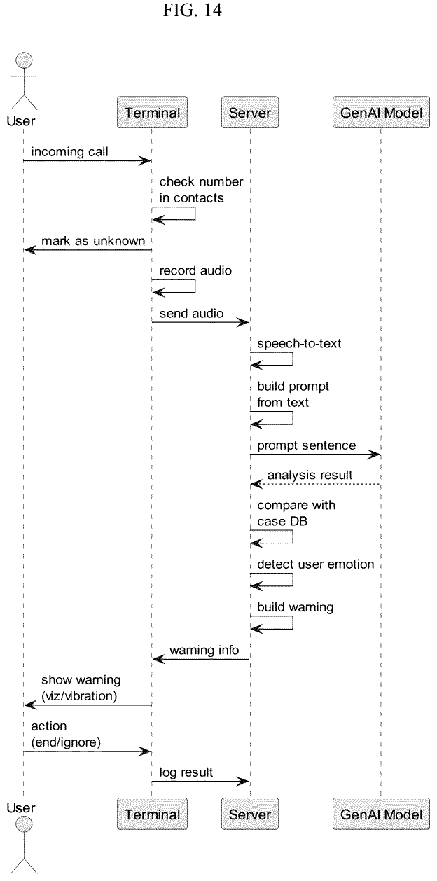

The following describes the processing flow using FIG. 14.

### Step 1

Terminal detects communication from unregistered identification information.

Terminal receives an incoming communication event from a telephony framework, with input including a caller identifier such as a phone number and a timestamp. Terminal queries an address database stored in local memory using the caller identifier as a key and executes a comparison operation to determine whether the identifier exists as a contact entry. Terminal outputs a registration status flag (e.g., “registered” or “unregistered”) and, when the flag indicates “unregistered,” terminal triggers subsequent risk-analysis processing for this communication.

### Step 2

Terminal acquires audio information associated with the unregistered communication.

Terminal uses an audio input unit and an audio capture module to sample the voice signal of the active communication. The input to this step is an audio stream from a microphone or system audio path, represented as analog sound pressure. Terminal performs analog-to-digital conversion and frames the signal into digital audio samples with parameters such as sampling rate and bit depth. Terminal outputs digital audio data chunks, each associated with metadata including a call identifier and chunk sequence number, and prepares these chunks for transfer to the server.

### Step 3

Terminal transmits audio data and communication metadata to the server.

Terminal receives as input the digital audio data chunks and the registration status flag, call identifier, and caller identifier. Terminal formats the audio data into network packets and encapsulates the chunks and metadata in a communication protocol message. Terminal applies encryption and addressing and sends the packets over a communication network to the server. Terminal outputs a sequence of network messages that represent the audio information stream and associated identifiers for the current communication.

### Step 4

Server reconstructs and buffers the audio stream per communication session.

Server receives as input the network messages containing audio data chunks and metadata from the terminal. Server parses the messages, verifies integrity, and groups audio chunks according to the call identifier and chunk sequence numbers. Server performs a sorting operation on the chunk sequence indices and concatenates the digital samples to reconstruct the audio stream in temporal order. Server outputs a reconstructed audio buffer stored in memory, along with structured session information including the unregistered identification information and session timing.

### Step 5

Server converts audio information into text data using a speech recognition technique.

Server receives as input the reconstructed audio buffer and language configuration parameters. Server applies preprocessing operations such as noise reduction, segmentation, and feature extraction to compute feature vectors from the audio samples. Server then applies an acoustic model and a language model, either locally or via a speech-to-text service, to map feature sequences to token sequences. Through decoding, server selects the most probable token sequence and converts it into a text string. Server outputs text data that represents a transcript of the communication content associated with the unregistered identification information.

### Step 6

Server generates a prompt sentence instructing analysis of the text data.

Server receives as input the transcript text and session context information (for example, “unregistered caller,” “voice call,” and language). Server executes a text-composition procedure that concatenates predefined instruction templates with the transcript and embeds placeholders for required outputs such as risk level and warning message. Server may insert control expressions such as “classify as LOW, MEDIUM, or HIGH” to constrain the generative output. Server outputs a complete prompt sentence in natural language that specifies an analysis task for a generative AI model.

### Step 7

Server submits the prompt sentence and the text data to a generative AI model.

Server receives as input the prompt sentence and, optionally, the raw or preprocessed transcript text. Server tokenizes the prompt sentence, converts tokens into numerical embeddings, and passes these embeddings through a generative AI model, for example a transformer-based neural network with multiple attention layers. Server controls generation parameters such as maximum output length and sampling temperature and executes forward-propagation computations through the network to obtain output token distributions. Server decodes the distributions to a text sequence, thereby generating analysis result information that may include a risk category, explanation, and candidate warning phrases. Server outputs this analysis result information as structured or semi-structured text.

### Step 8

Server compares the analysis result information with case information recorded in an information resource.

Server receives as input the analysis result information and case information records stored in a database. Server extracts key phrases, risk labels, or numerical scores from the analysis result and computes semantic or statistical feature vectors. Server retrieves candidate case records using indexing keys or approximate nearest-neighbor search and computes similarity measures, such as cosine similarity, between the current feature vectors and stored case feature vectors. Server then aggregates similarity values and risk attributes from the matched cases with the analysis result information to compute risk evaluation information, for example a final risk score and category. Server outputs the risk evaluation information as a refined determination of improper activity or solicitation activity likelihood.

### Step 9

Server estimates a user emotional state from user audio information or user text data.

Server receives as input user audio information captured during the communication, or user text data derived from speech recognition of user utterances. Server applies feature extraction to compute acoustic descriptors such as pitch, energy, and spectral properties, and may also compute linguistic features such as sentiment indicators from user text data. Server feeds these features into an emotion-classification model implemented as a trained neural network or statistical classifier. The classifier processes the feature vectors and outputs probability values for possible emotional categories. Server selects the category with the highest probability or a set of categories above a threshold and outputs an emotional state label, optionally with a confidence value.

### Step 10

Server generates warning information based on the risk evaluation information and the emotional state.

Server receives as input the risk evaluation information (including a risk category and score) and the emotional state label. Server executes a rule-based or algorithmic synthesis process that selects or constructs a warning message string and determines presentation parameters such as character size, color, display duration, and vibration pattern. Server, for example, may map a high-risk evaluation and a fearful emotional state to a strongly worded message and a large red font with strong repeated vibration. Server structures these elements into warning information that includes both semantic content and interface control parameters. Server outputs the warning information as a data object to be delivered to the terminal.

### Step 11

Server transmits the warning information to the terminal for user notification.

Server receives as input the warning information and addressing information for the target terminal. Server formats the warning information into a network message compatible with a push-notification or message-delivery system, including fields for message text and presentation parameters. Server applies encoding and security operations and sends the message through a communication network to the terminal. Server outputs a delivered warning-information packet that the terminal can interpret to present the warning to the user.

### Step 12

Terminal presents the adjusted warning information to the user via a user interface.

Terminal receives as input the warning information message from the server. Terminal parses the message to extract a warning text string, risk indicators, and presentation parameters. Terminal controls a display device to render the warning text with specified character size and color, and controls a vibration actuator to generate vibrations according to the pattern defined in the warning information. Terminal may overlay the warning on an active call screen so that the user can observe it immediately. Terminal outputs visual and haptic signals that constitute a user-perceivable warning.

### Step 13

User responds to the warning and optionally changes communication behavior.

User receives as input the visual and haptic warning output from the terminal. User interprets the warning text and risk indication and may operate an input device such as a touchscreen to select an action, including terminating the communication, blocking the identification information, or ignoring the warning. User thereby produces an action output that affects the continued existence of the communication, and the terminal or server can record this user response for later analysis or adaptation of processing parameters.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

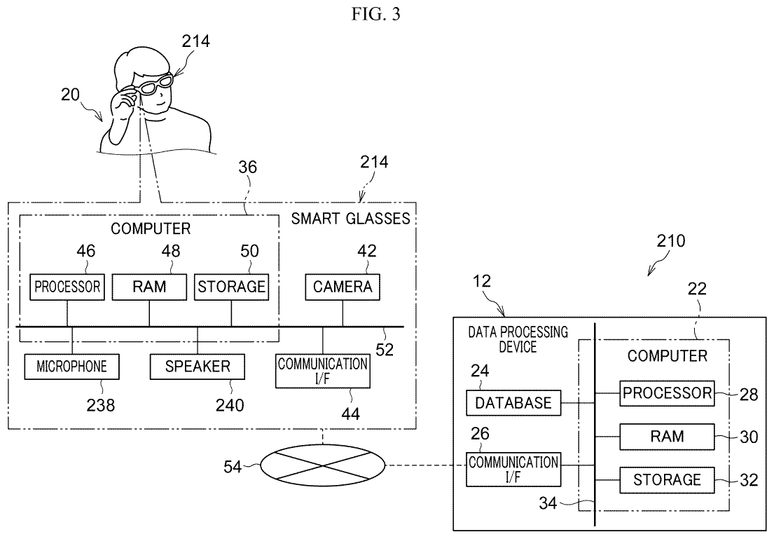

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

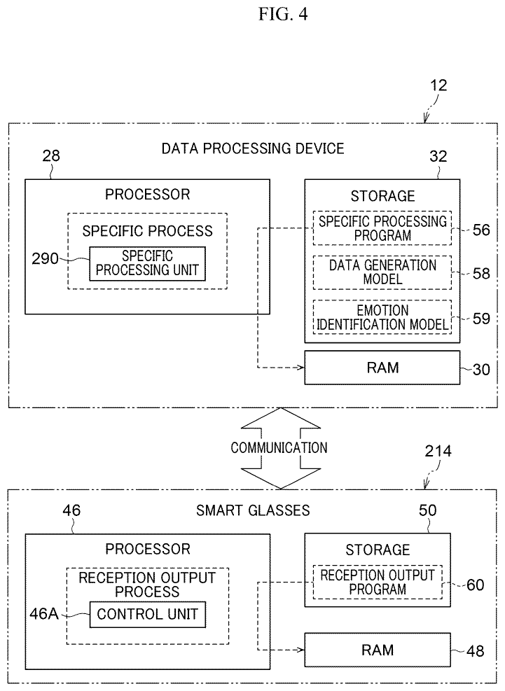

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

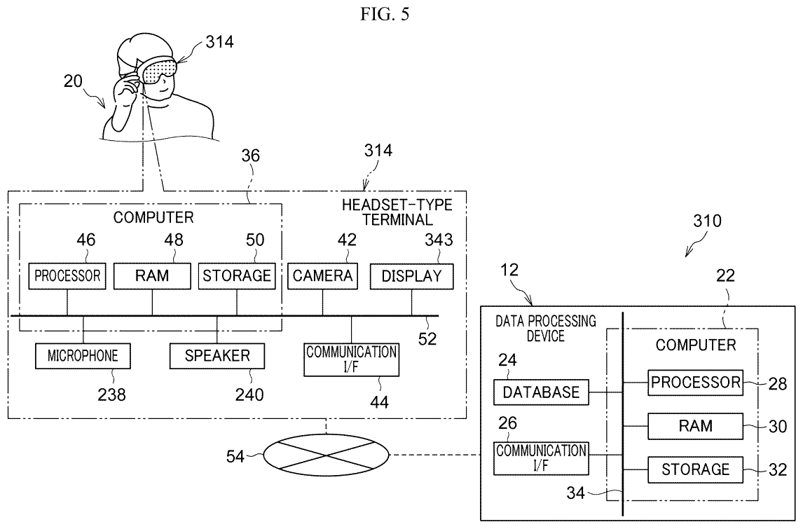

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

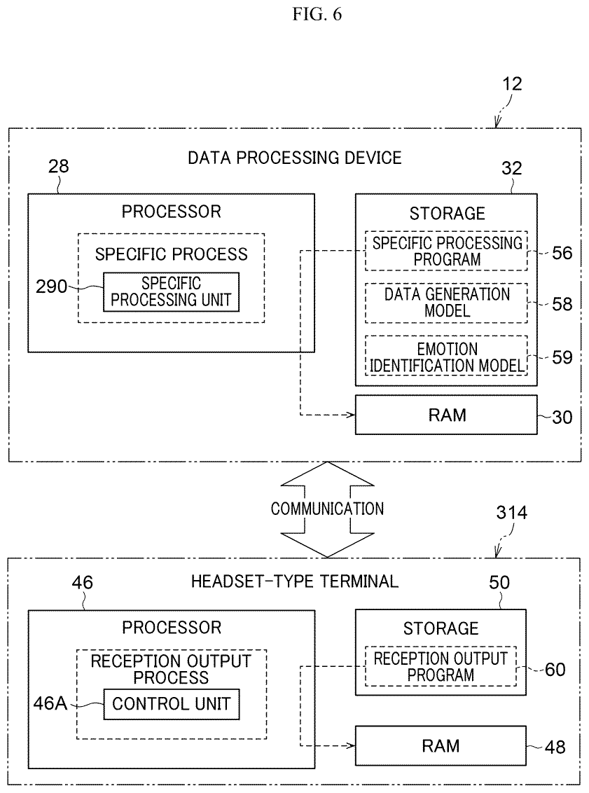

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

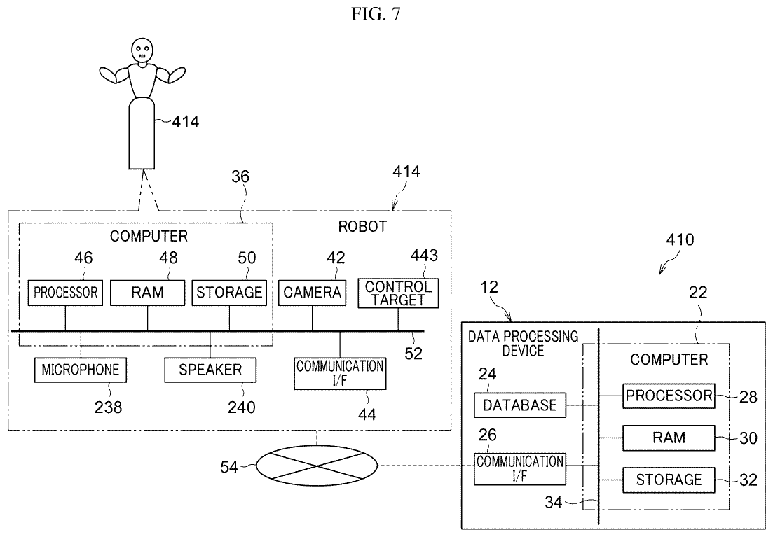

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

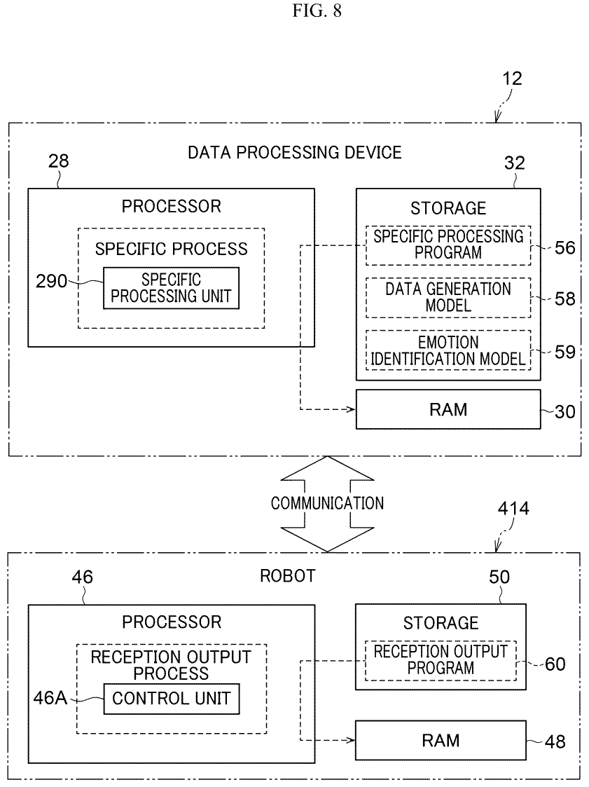

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

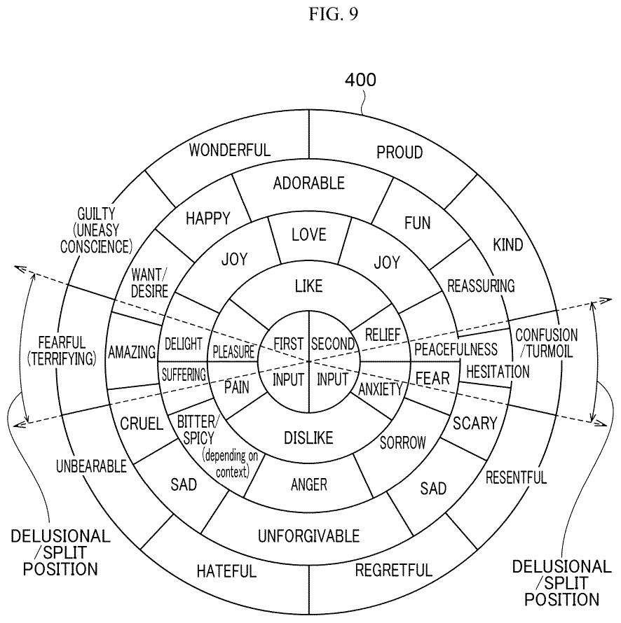

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

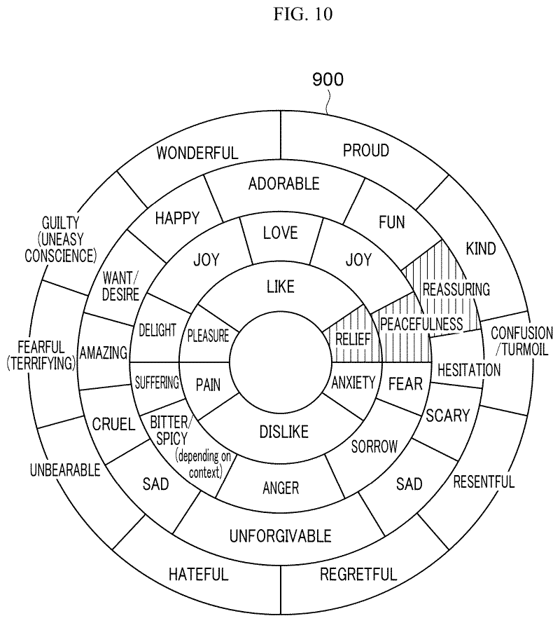

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
detect, at a communication terminal, a communication having identification information that is not registered in a contact storage unit and acquire audio information associated with the communication and store the audio information as recording data,
receive, from the communication terminal, the recording data and convert the recording data into text data by using a speech recognition technique executed by an information processing apparatus,
generate analysis request data including the text data and a prompt sentence for causing a generative AI model to determine whether the text data is related to fraudulent activity or unnecessary sales activity, and input the analysis request data to the generative AI model, obtain an analysis result output from the generative AI model and compare the analysis result with an information resource in which a plurality of case data are stored to determine a risk type and a risk level of the communication,
generate warning information indicating a possibility that the communication corresponds to deceptive behavior or solicitational behavior based on the risk type and the risk level, and transmit the warning information as notification data to the communication terminal so that the warning information is presented to a user via the communication terminal.

### Supplementary 2

The system according to supplementary 1,
wherein the processor is configured to
cause the communication terminal, upon receiving the notification data, to execute user interface processing in which the warning information included in the notification data is immediately displayed as a visual warning message by using a notification function of a terminal device, and in which an operation by the user to block or permit the communication having the identification information is accepted based on the warning message.

### Supplementary 3

The system according to supplementary 1,
wherein the processor is configured to
cause the prompt sentence to include an instruction for classifying, with respect to the text data, at least one of a possibility that the communication is fraudulent activity, a possibility that the communication is unnecessary sales activity, and a possibility that the communication is low risk, and an instruction for causing the generative AI model to output the analysis result in a predetermined structured format, and to generate the warning information so as to include the risk type, the risk level, and a concise reason description based on the structured format.

### Application Example 1

### Supplementary 1

A system comprising a processor and a memory storing directory information and communication history information,
wherein the processor is configured to
detect, via a communication line and based on incoming call information acquired from a terminal device, that identification information included in the incoming call information is not included in the directory information stored in the memory, and thereby detect an unregistered communication,
acquire audio information associated with the unregistered communication from at least one of the terminal device and the memory, input the audio information to a speech recognition apparatus using a speech recognition technique, obtain text data converted from the audio information, and store the text data in association with the identification information in the memory,
generate a prompt sentence including at least the text data and communication-related contextual information regarding the unregistered communication, transmit the prompt sentence as input to a generative artificial intelligence model executed by an information processing apparatus, and obtain, from the information processing apparatus, an analysis result in response to the prompt sentence,
compare the analysis result with reference information including at least one of external information resources accessible via an information network and communication history information stored in the memory, and generate evaluation information indicating at least a risk level of fraudulent activity and a reason for the risk level based on the analysis result and a comparison result,
create warning information corresponding to the evaluation information, generate notification data including the warning information, and transmit the notification data to the terminal device so as to cause the terminal device to display the warning information to a user, and
update, based on at least one of a response operation and an evaluation operation received from the terminal device, at least one of the identification information and the evaluation information stored in the memory as history information, and correct at least one of a generation condition of the prompt sentence and a generation condition of the evaluation information.

### Supplementary 2

The system according to supplementary 1,
wherein the processor is configured to change at least one of wording, emphasis level, and display format of the warning information included in the notification data in accordance with the risk level included in the evaluation information, and to cause the terminal device to immediately present the warning information visually on a display screen of the terminal device.

### Supplementary 3

The system according to supplementary 1,
wherein the processor is configured to include, in the prompt sentence, an instruction requesting the generative artificial intelligence model to determine whether the text data is likely to correspond to fraudulent activity or to a legitimate commercial activity, and to output the risk level in accordance with a predetermined classification, and to include, in the warning information, explanation information indicating at least the risk level and the reason obtained from the generative artificial intelligence model so that the user can confirm details of the warning.

### Example 2

### Supplementary 1

A system comprising a processor,
wherein the processor is configured to
detect, by using a communication control unit in a communication terminal, a communication connection originating from identification information that is not included in identification information managed by a registration information management unit of the communication terminal,
acquire, by using an acoustic input unit and a voice acquisition unit of the communication terminal, voice information relating to the communication connection, and convert the voice information into character information by using a speech recognition unit,
generate, in a server, a prompt sentence including the character information and attribute information relating to the communication connection, input the prompt sentence into a generative information processing model, and obtain an analysis result relating to a possibility of fraudulent activity from the generative information processing model, compare, in the server, the analysis result with past case information stored in an information storage unit, and generate evaluation information relating to the possibility of fraudulent activity,
generate, in the server, warning information on the basis of the evaluation information, and transmit the warning information to the communication terminal by using a notification control unit,
present, in the communication terminal, the warning information to a user immediately by using a user-directed display unit,
transmit, in the communication terminal, response-operation information to the server when the user selects a response operation relating to the communication connection on the basis of the warning information, and store, in the server, the response-operation information in the information storage unit, and
update, in the server, a generation condition of at least one of the prompt sentence and the warning information on the basis of stored information in the information storage unit.

### Supplementary 2

The system according to supplementary 1,
wherein the processor is configured to transmit, from the server to the generative information processing model, the prompt sentence including the character information as an inquiry sentence having a meaning equivalent to “Does this communication content have a possibility of fraudulent activity?”, and to obtain from the generative information processing model at least decision information indicating presence or absence of fraudulent activity and reason information indicating a reason for the decision.

### Supplementary 3

The system according to supplementary 1,
wherein the processor is configured to cause the server to instruct the generative information processing model, via the prompt sentence including the character information, to generate a structured output, to obtain from the generative information processing model a machine-readable output including truth-value information indicating whether the communication corresponds to fraudulent activity, level information indicating a risk level, and explanation information indicating a reason for the risk level, and to control an importance level and a presentation mode of the warning information on the basis of the machine-readable output.

### Application Example 2

### Supplementary 1

A system comprising a processor,
wherein the processor is configured to
detect communication from identification information that is not registered in an address database,
acquire audio information related to the communication from the unregistered identification information and convert the audio information into text data by using a speech recognition technique,
generate a prompt sentence that instructs analysis of the text data and input the prompt sentence to a generative AI model to obtain analysis result information,
compare the analysis result information with case information recorded in an information resource to generate risk evaluation information relating to at least one of improper activity and solicitation activity,
generate warning information that performs notification to a user based on the risk evaluation information,
estimate an emotional state of the user based on at least one of user audio information and user text data acquired during the communication,
dynamically adjust content and presentation format of the warning information according to the emotional state and the risk evaluation information, and
notify the adjusted warning information to the user.

### Supplementary 2

The system according to supplementary 1,
wherein the processor is configured to
present the adjusted warning information visually or haptically through a user interface in order to display the warning information immediately, and change at least one of character size, color, display area, and vibration pattern based on the emotional state and the risk evaluation information.

### Supplementary 3

The system according to supplementary 1,
wherein the processor is configured to
include in the warning information a concrete alert phrase indicating at least one of a possibility of improper activity and a possibility of solicitation activity with purchase intention, and a summary of the analysis result information used to generate the alert phrase,
such that the user can selectively refer to detailed information of the alert phrase through the user interface.

What is claimed is:

1. A system comprising:
circuitry configured to:
detect, via a communication interface coupled to a packet-switched network, an incoming communication connection originating from identification information that is not included in identification information managed by a registration information management unit;
acquire audio information associated with the incoming communication connection via an acoustic input unit, and convert the audio information into character information by executing speech recognition processing;
generate a prompt data structure including the character information and attribute information relating to the incoming communication connection, and transmit the prompt data structure to a generative information processing model via the communication interface;
obtain an analysis result from the generative information processing model, compare the analysis result with case information stored in an information storage unit, and generate evaluation information based on the comparison; and
generate warning notification data based on the evaluation information, and transmit the warning notification data as a notification data packet to a terminal device of a user via the packet-switched network.

2. The system according to claim 1, wherein the circuitry is configured to instruct, via the prompt data structure, the generative information processing model to classify the character information with respect to at least a first category indicating a possibility of deceptive activity, a second category indicating a possibility of solicitation activity, and a third category indicating low-risk activity, and to output the analysis result in a predetermined structured format.

3. The system according to claim 2, wherein the predetermined structured format includes at least decision information indicating presence or absence of deceptive activity, a risk level indicator, and reason information indicating a basis for the decision.

4. The system according to claim 1, wherein the circuitry is configured to cause the terminal device to execute user interface processing in which the warning notification data is immediately displayed as a visual warning message, and in which an operation by the user to block or permit the incoming communication connection is accepted based on the visual warning message.

5. The system according to claim 4, wherein the circuitry is configured to change at least one of a character size, a color attribute, a display area dimension, and a haptic output pattern of the visual warning message based on the evaluation information.

6. The system according to claim 1, wherein the evaluation information includes a risk type classification and a risk level value, and the warning notification data includes the risk type classification, the risk level value, and a concise reason description derived from the analysis result.

7. The system according to claim 1, wherein the circuitry is configured to receive response-operation information from the terminal device when the user selects a response operation relating to the incoming communication connection based on the warning notification data, and to store the response-operation information in the information storage unit.

8. The system according to claim 7, wherein the circuitry is configured to update a generation condition of at least one of the prompt data structure and the warning notification data based on stored information accumulated in the information storage unit over a plurality of communication connections.

9. The system according to claim 1, wherein the circuitry is configured to perform the speech recognition processing by applying a trained acoustic model to the audio information to generate a token sequence, and to perform language model decoding on the token sequence to produce the character information.

10. The system according to claim 1, wherein the case information stored in the information storage unit includes a plurality of case records, each case record including at least a communication pattern descriptor, a risk classification label, and a temporal identifier, and the circuitry is configured to compare the analysis result against the plurality of case records by computing a similarity measure between the analysis result and each case record.

11. The system according to claim 10, wherein the circuitry is configured to retrieve case records from an external information resource via the communication interface and update the information storage unit with retrieved case records.

12. The system according to claim 1, wherein the circuitry is configured to acquire the audio information in real time during the incoming communication connection, and to perform the speech recognition processing, the generation of the prompt data structure, and the generation of the warning notification data concurrently with the incoming communication connection.

13. The system according to claim 1, wherein the attribute information relating to the incoming communication connection includes at least one of the identification information, a communication timestamp, a communication duration, and geographic origin information derived from the identification information.

14. The system according to claim 1, wherein the circuitry is configured to estimate an emotional state of the user based on at least one of user audio information and user text data acquired during the incoming communication connection, and to dynamically adjust content and a presentation format of the warning notification data according to the emotional state and the evaluation information.

15. The system according to claim 14, wherein the circuitry is configured to, when the emotional state indicates a state of anxiety, increase a prominence level of the warning notification data by modifying a display attribute of the visual warning message.

16. The system according to claim 1, wherein the circuitry is configured to generate the prompt data structure to include a context summary derived from communication history information associated with the identification information stored in the information storage unit.

17. The system according to claim 1, wherein the circuitry is configured to store the character information, the analysis result, and the evaluation information in association with the identification information and a session identifier in the information storage unit for subsequent retrieval.

18. A system comprising:
circuitry configured to:
detect, via a communication interface coupled to a packet-switched network, an incoming communication connection originating from identification information that is not included in identification information managed by a registration information management unit;
acquire audio information associated with the incoming communication connection and convert the audio information into character information by executing speech recognition processing;
generate a prompt data structure including the character information and attribute information relating to the incoming communication connection, and transmit the prompt data structure to a generative information processing model via the communication interface;
obtain an analysis result from the generative information processing model in a predetermined structured format including a risk classification and a risk level;
compare the analysis result with case information stored in an information storage unit and generate evaluation information;
generate warning notification data based on the evaluation information and transmit the warning notification data as a notification data packet to a terminal device via the packet-switched network;
receive response-operation information from the terminal device and store the response-operation information in the information storage unit; and
estimate an emotional state of the user and dynamically adjust a presentation format of the warning notification data based on the emotional state.

19. The system according to claim 18, wherein the circuitry is configured to update a generation condition of the prompt data structure based on accumulated response-operation information in the information storage unit, and to apply the updated generation condition to subsequent incoming communication connections.

20. A method performed by circuitry, the method comprising:
detecting, via a communication interface coupled to a packet-switched network, an incoming communication connection originating from identification information that is not included in identification information managed by a registration information management unit;
acquiring audio information associated with the incoming communication connection via an acoustic input unit, and converting the audio information into character information by executing speech recognition processing;
generating a prompt data structure including the character information and attribute information relating to the incoming communication connection, and transmitting the prompt data structure to a generative information processing model via the communication interface;
obtaining an analysis result from the generative information processing model, comparing the analysis result with case information stored in an information storage unit, and generating evaluation information based on the comparison; and
generating warning notification data based on the evaluation information, and transmitting the warning notification data as a notification data packet to a terminal device of a user via the packet-switched network.
